(19) United States
(12) Patent Application Publication
(10) Pub. No.: US 2015/0112766 A1
(43) Pub. Date: Apr. 23, 2015

(54) Method and Apparatus for Rapid Metrological Calibration, Intervention Assignment, Evaluation, Forecasting and Reinforcement

(71) Applicant: Leaderamp, Inc., Vacaville, CA (US)

(72) Inventor: Matthew Barney, Vacaville, CA (US)

(73) Assignee: Leaderamp, Inc., Vacaville, CA (US)

(21) Appl. No.: 14/060,448

(22) Filed: Oct. 22, 2013

(51) Int. Cl. G06Q 30/02

(52) U.S. Cl. CPC G06Q 30/0203
USPC 705/7.32

(57) ABSTRACT

An improved method and apparatus for automated metrology, intervention assignment, evaluation, and forecasting is disclosed. The embodiments include innovative algorithms for stakeholder management, item generation, feedback, and progress tracking.

### BACKGROUND OF THE INVENTION

Measurement, feedback and development are central to development efforts in nearly every profession. From developing leaders, to childhood education, Human Resource Management, and sports, it is widely known to those skilled in the prior art that measurement, developmental challenges and support are required to grow. Similarly, in high-stakes domains, getting multiple perspectives to measure a person is required or desired. These include medical settings where multiple judgments are desired to make difficult tradeoffs between patient outcomes, costs and risks. They also include multi-billion dollar risks on senior-leader (e.g. CEO) selection procedures. Further, most leadership development is based on ratings from multiple stakeholders, known in the prior art as 360 degree, 180 degree, 570 degree, or multisource surveys. But these forms of feedback contain significant bias, so much bias that those skilled in the prior art often find twice the variance from the severity/leniency of the rater than they do from the target (e.g. person being measured). They also contain hidden agendas, sloppy responses and intentional misrepresentation all of which can distort the accuracy and precision of measurement. The prior art lacks a solution that automatically integrates this measurement on a metrological device that produces focused feedback for development or other decisions such as personnel selection or placement. Prior art innovations are slow, inaccurate, imprecise and impractical for many domains.

Measurement is central to the evaluation and improvement of all types of assets, both tangible and intangible. Raw data are collected for human metrology with prior art methods such as assessments, questionnaires, surveys, checklists, tests, quizzes and/or through unobtrusive “behavioral residuals” in the hope that they may be representative of a latent (unobserved) or manifest (observed) attribute. A physical science analogue is with a thermometer, where heat is measured indirectly, inferred from the linear rise of mercury at it expands with increases in amounts of heat. But the same thermometer may be useless in measuring extremely cold or hot temperatures, that require differently calibrated instruments. The same is true for modern human metrological devices.

In order for human measurement to be as useful as thermometers and rulers, raw data must also be turned into linear units of information that can be concatenated. Those skilled in the prior art (e.g. psychometricians, metrologists, statisticians) will know that linear measures ideally have a theoretically-relevant absolute zero and that such linear properties with an approximate zero point are preferred and/or required for many statistical analyses (e.g. parametric tests). But prior art inventions make it difficult to produce engineering-worthy social science measures that meet the same standards as those from physical sciences (e.g. Kelvin scale). The prior art requires custom programming from Ph.D.-level psychometricians, making it relatively unavailable to the lay public.

Further, the content upon which human metrology rests itself changes. While the taxonomies of human abilities, traits, attitudes, beliefs, and values may be relatively finite—the knowledge (procedural, syntactic, declarative), skills (e.g. mental models) and behaviors people must master continually change as advances in science, technology improve, and as markets change dynamically.

What is needed and unavailable in the prior art is a way to automate the creation and deployment of engineering and finance-worthy metrological devices for these sorts of intangibles in order to usefully detect and mitigate risk in a plurality of metrological domains. These include but are not limited to examples such as the measurement of entrepreneurship, medical judging, customer loyalty, wine tasking, personality, knowledge, skill and executive leadership behavior.

Further no prior art invention provides a plurality of useful feedback and risk-mitigation actions matched uniquely to a plurality of needs for a tailored application (e.g. a leader) at a calibrated range of utility for a large audience (e.g. billions of people on the internet). In particular, a parsimonious, short and rigorous assessment procedure that leverages a plurality of raw data types (e.g. self-report, multisource/360, unobtrusive, situational judgment, test) is laborious, inelegant, expensive and difficult with prior art inventions. Further, no prior art inventions contain a plurality of solutions matched to said metrological outputs' confidence intervals for mass customization of interventions that are desired to drive growth, improvement and/or risk mitigation.

### SUMMARY OF THE INVENTION

### Stakeholder Management Innovations

Prior art multisource (e.g. 360 degree surveys) methods are not able to automatically manage a critical component to the stakeholder measurement process—a plurality of persuasive reminders that are known to those skilled in the prior art to be a serious problem with current technologies. Multisource surveys, by definition, require a plurality of geographically distributed stakeholders to make ratings. Further, many important metrological situations involve raters in other time zones, especially senior leader measurement (e.g. Multinational CEO, Board of Directors), customer satisfaction and internet-based judging measurements. It is known to those skilled in the prior art that it is difficult and time consuming to secure ratings in a timely fashion. Current art methods resort to with email reminders, and other offline strategies (e.g. telephone) to persuade them to complete their surveys.

The current invention provides a plurality of administrator, stakeholder, or target (e.g. entrepreneur subject to a due diligence assessment) features that enable the real-time, dynamic and automated management of stakeholders. As measurement projects progress through the stages of a multisource survey, the current invention includes the use of a plurality of item types including but not limited to classical items such as those with stems and response alternatives. The spirit and scope of the current invention includes but is not limited to hotspot, video, semantic differential, likert and other mechanisms to collect raw data including unobtrusive measures in a virtual world/serious game or website forum activities tracked electronically.

Those knowledgeable in the prior art will recognize that current-art technologies require significant manual effort to identify, solicit, and secure useful feedback from others in a multisource embodiment. But similarly, experts in the prior art will recognize the scientific evidence confirming the superiority of multisource embodiments for the measurement of some dimensions (e.g. personality) over self-reports (e.g. Oh & Berry, 2009; Connelly, & Ones, 2010; Oh, Wang & Mount, 2011). The current invention leverages a plurality of methods that automate multisource and other forms of useful measurement and developmental feedback.

### Item Generation Innovations

Prior art innovations cannot automatically generate and then subsequently calibrate new items for one or more scales simultaneously such that they meet the requirements for objective measurement (Rasch 1960/1980). Prior art methods typically use domain experts to write items for a given target domain that is needed to be assessed. The current invention may use these common approaches, or automated approaches both of which are preferred to use use construct maps that encourage manual or automated item writers to attempt to write items at each level of the latent trait of interest with a sufficiently fine-grained level of detail to be useful (Wilson, 2005). Next, prior art inventions are used such as web-based surveys to collect data on either all of the items, or an overlapping bundle of items that are slightly different for each person. Subsequently, the current technologies require the analyst to manually export said data, and manually import into another software package that iterates until a calibrated set of facets (e.g. dimensions) and elements (e.g. items, people, types, situations) measures meet the analyst's quality standards.

The current invention introduces a plurality of seamlessly integrated methods into the item generation, raw data collection, and subsequent facet calibration process to improve the speed with which a plurality of new items and solutions can be simultaneously generated. The preferred embodiment provides an administrator's Graphical User Interface (GUI) whereby the analyst can provide instructions (e.g. a video, text, pictures) via a cloud-based Content Management System (CMS) in order to establish a new requirement for measurement and development.

The system allows the administrator to use CMS systems in the prior art (e.g., Plone, Drupal) along with email and social-media-based permissions to solicit assistance with metrological tasks. Tasks may range from crowd-sourced based item writing, to rating key stakeholders to identifying appropriate solutions that may be used to improve a given dimension at a specific level of interest (e.g. “log-odds unit). In the embodiment that solicits help to generate items, select subject matter experts (SME) are invited to provide an opportunity to draft items and solutions at each of the “tick marks” on the “ruler(s)” desired. As the SME enters items and solutions using a keyboard, mouse and/or voice recognition software available in the prior art, the system calculates how many more items may be required based on the minimum item standards set by the analyst (to ensure sufficient items will meet subsequent empirical quality standards) and analysts' estimates of how many items will fail the apriori quality control criteria. The preferred embodiment uses these calculations to report back to the administrator or analyst the status of the item generation initiative via email or cloud-based dashboard, so that the administrator may manage the timeliness of the completion of the process by either persuading SMEs to complete more items, or adding more SMEs to the item generation project.

In situations where a plurality of Subject Matter Experts should contribute to the development of an item bank, the system provides the capability for the analyst to allow the SME to nominate other users to write items or propose solutions. This provides a social media mechanism (e.g. API with LinkedIn, Facebook, Twitter) to solicit a broader array of SMEs than may be known to the test constructor and is unavailable with prior art assessment item generation technologies. The current innovation provides a GUI to allow the recording and/or uploading of video, audio and/or text-based data for the work done by the Subject Matter Expert. It provides an End-User Licensing Agreement (EULA) specifying the user's rights and obligations, and the nature of the task requested, with any benefits (e.g. payment, reciprocity, certificate of appreciation) in exchange for their contributions consistent with international data privacy laws and practices, and with scientific practice around transparency for human subjects. The preferred embodiment encourages the SME to draft new items at specific levels of expected difficulty that the system has identified as lacking a sufficient number, based on the Analysts' apriori preference for the total number of items by anticipated log-odds unit level. Further, the preferred embodiment allows the analyst to have SMEs propose specific interventions (e.g. courses, experiences, job aides, recipes) or other solutions related to the same content, at a particular level on the scale. Next, the preferred embodiment allows the SME to trigger social media (e.g. Twitter, Facebook, LinkedIn, USENET), Short Messaging Service (SMS) or email-based invitations to invite other SMEs to similarly provide input. The preferred embodiment subsequently provides new SMEs the same instruction and requests them to write new item/solution bundles in the areas that have the smallest number or lowest until fuzzy logic determines that their workload is complete or there are sufficiently large number of items to stop. The system tracks this progress for the administrator/analyst, such that they too can send reminders, and stop the study early if required. These innovations can then feed prior-art automated self-report or testing assessment technologies (e.g. Computer-Adaptive Testing), or the current invention's preferred embodiment, an automated multisource assessment.

Stakeholder Management Innovations

For multisource measurement, prior art innovations such as J. Michael Linacre's Facets program and related algorithms (www.winsteps.com) require multiple manual iterations before items, people and other facets may be calibrated. The current invention provides a plurality of alternatives to make this process fully automated including fuzzy logic to automate iterations done in a plurality of methods but are not limited to iteration procedures such as Conditional Maximum Likelihood or Joint Maximum Likelihood approaches known to those skilled in the prior art. It is within the spirit and scope of the invention to utilize other estimators of facet locations, including a novel approach based on apriori or Bayesian estimates of facet locations that is described below.

### Feedback Innovations

Feedback based on measurements is crucial to understand areas for improvement, and for motivational, directional and developmental cues that drive a plurality of improvement actions. Experts skilled in the prior art will recognize that the best feedback is tailored to the person who will receive it. Suggestions for actions that are either too easy or too difficult will not provide the optimal developmental experience for the recipient. Both educational (e.g. Bloom's/Anderson's Taxonomy) and psychometric theory suggest that the maximum amount of information and developmental benefit occurs when the item and intervention are matched with the person's location on the dimension of interest. Prior art inventions cannot automatically provide said feedback in a completely tailored way for a single dimension, let alone across multiple dimensions as is the case with the current invention's preferred embodiment. The preferred embodiment at the outset of a new, previously uncalibrated scale of the current invention is to use the analyst′ empirically weighted predictor set to make specific developmental recommendations for the target (e.g. leader) based on the likelihood of desired outcomes and the current location of the target's dimensions. The current invention uses a database of likely interventions matched to the target's current locations that are below the level required to produce a high probability of achieving one or more objectives (criteria). Intervention data are either sourced from SMEs using the previously noted technology to source new items, or are from an archive of vetted solutions inputted by the administrator using their device's access to the cloud. Prior art solutions are unable to recommend a portfolio of solutions that, together, are likely to help the person improve given prior scientifically validated predictive equations stored in the system's cloud database. The preferred embodiment uses optimization algorithms (e.g. Genetic Algorithms, Simulated Annealing) known to those skilled in the prior art to examine the likely future predicted outcomes when a dynamic combination of alternative solutions are considered prior to recommending in the reporting engine. Further, the preferred developmental embodiment uses a Monte Carlo simulation method to estimate likely improvement levels and “what if” scenarios if the leader improves in the set, the improvement in the predicted outcomes using apriori forecast equations (e.g. regressions, Structural Equation Models). The preferred embodiment includes a graphical interface to allow the administrator or SME to input the range of appropriate application of a given intervention, for individuals who are between two points on the metrological line. The administrator inputs fuzzy logic to suggest bundles of interventions, that are subsequently color-coded to aide in communication with the end user. For example, a given report will include color ranges that are red, meaning unlikely to help the person given their score; yellow=difficult but achievable; or green=likely to be most developmental). The system uses Bayesian threshold measures associated with each color, number, textual, pictoral, audio, and/or video display to communicate likely impact before the end user embarks on an unfruitful improvement effort. The same Bayesian estimates are then used to recommend a focused subset of interventions/investments relevant just to the targeted person who was assessed. Further, the preferred embodiment uses a plurality of optimization forecasts to graphically report the confidence intervals that shrink, or become more certain, as the end-user adds solutions to their portfolio thereby improving their odds of improvement.

### Progress Tracking

Further, the preferred embodiment of the invention is for the feedback to be compared across time, with respect to whether or not a person or object has improved from a prior period, and whether or not planned actions will be sufficient. Prior art inventions have neither hardware nor software that is able to continuously calculate and then compare confidence intervals. The preferred embodiment of the system has administrator-established threshold levels that report textual, pictoral or video outputs as to whether a subsequent measurement was statistically greater than, equal to, or less than the prior measurement. Further, no prior art inventions include the translation of confidence intervals into fuzzy-logic based expert system to suggest additional actions that are within the current confidence interval to improve the probability of subsequent development.

Prior art developmental interventions that are formal (e.g. courses, books, simulations) and informal (e.g. experiential, self-reflection, coaching, mentoring) are designed to improve one or more domains of expertise. While one prior art invention is able to recommend specific solutions that are job related (US2000/6070143), there are no prior art inventions that specifically match the location of the person/object/facet being measured with the portfolio of solutions that together improve the odds of growth. This is achieved by the current inventions' cloud-based algorithm that calculates and then evaluates whether or not prior and current estimates overlap, given measurement error (confidence intervals), with those of the person, object, or facet. In this way, the current invention is a superior mechanism to mass-customize highly focused feedback about specific remediation strategies, courses, experiences, books (e.g.) or bundles thereof. This includes celebratory feedback and programmed rewards, such as is available with cryptocurrency (e.g. Bitcoin) or other currency-based rewards known to those skilled in the prior art.

The combination of fuzzy logic and symbols to indicate the degree to which the measurement information can be trusted is one new aspect to the invention. The preferred embodiment includes an interface for the administrator to specify the specific quality control criteria on measurements known to those skilled in the prior art such as Inlier-Weighted, Outlier-Weighted or Point-Measure correlations that determine the likely usefulness of the resultant measures. The current invention allows the administrator to establish a table of fuzzy logic threshold values for a plurality of quality control statistics to report both the measure, and the interpretability of the measure in a simple way that is appropriate for the end user who is not proficient with psychometrics. When the administrator-defined fuzzy thresholds are breached, the system provides feedback (e.g. text, audio, video, pictures) about how and whether to interpret the result. For example, one embodiment is for the confidence interval bar to change its color, line width, and or dash type to indicate the overall quality of the information contained in the underlying measurement estimate. Another is to use symbols (e.g. smiley face, neutral face, frowning face; skull and crossbone) to depict the overall usefulness of the information. The preferred embodiment is to use a score that combines the information across all quality control statistics based on specifications established by the expert metrological administrator to produce a single value (e.g. CpK, CpM or Sigma metric) that the system references in a database table to produce the resultant translated, “lay” display.

### Multisource Embodiment

The current invention uses an integrated plurality of methods to improve the speed, quality and integration of measurement, feedback and development. One embodiment is multisource, also known as 360 degree surveys that are the most appropriate to measure certain types of constructs (e.g. personality, social capital) and can also be used to trigger or evaluate past, current or future feedback and development interventions, especially for observable behaviors or collective views of a single object such as a product or service.

The invention includes novel solutions to automated and target-managed stakeholder management, and substantial improvements to the quality and speed of the measurement, reporting, and development processes.

### BRIEF DESCRIPTION OF THE DRAWINGS

FIG. 1A depicts a computing device.

FIG. 1B depicts a computing device communicating with a cloud computer.

FIG. 2 depicts a Measurement Automation Algorithm.

FIG. 3 depicts a Scale Disordering Correction Algorithm.

FIGS. 4A, 4B, and 4C depict a Facet Distortion Correction Algorithm.

FIG. 5 depicts graphics user interfaces (GUIs) used on a computing device.

FIG. 6 depicts a Social Media Solution Harvesting Algorithm.

FIG. 7 depicts an Algorithm for Session-Based Item Seed and Iterative Calibration.

FIG. 8 depicts a Historical Seed Value Algorithm.

FIG. 9 depicts an Expert System Tradeoff Analysis Algorithm.

FIG. 10 depicts an Iterative Drill-Down-Detail Algorithm.

FIG. 11 depicts a Fuzzy Surprise Scrutiny Algorithm.

FIG. 12 depicts a Commitment Forecast and Mitigation Algorithm.

FIGS. 13A and 13B depict a Target By Rater Optimization Algorithm.

FIG. 14 depicts an Automated Optimized Planning Algorithm.

FIG. 15 depicts a Predicted Seed Algorithm.

FIG. 16 depicts a Relevant Dimensions Just In Time Algorithm.

FIG. 17 depicts a Calibration Algorithm.

FIG. 18 depicts an Algorithm for Automatically Managing Deployments.

FIG. 19 depicts a Rater Bias Prevention Algorithm.

FIG. 20 depicts a Dynamic Rate Bias Remediation Algorithm.

FIG. 21 depicts a Social Media Item Generation and Calibration Algorithm.

FIG. 22 depicts a Rater Remediation Algorithm.

FIG. 23 depicts a Verification of Rate Sample Algorithm.

FIG. 24 depicts an Algorithm for Rate Enthusiasm Improvement.

FIG. 25 depicts a Fatigue Prevention and Optimization Algorithm.

FIG. 26 depicts a Longitudinal Modeling and Evaluation Algorithm.

### DETAILED DESCRIPTION OF THE PREFERRED EMBODIMENTS

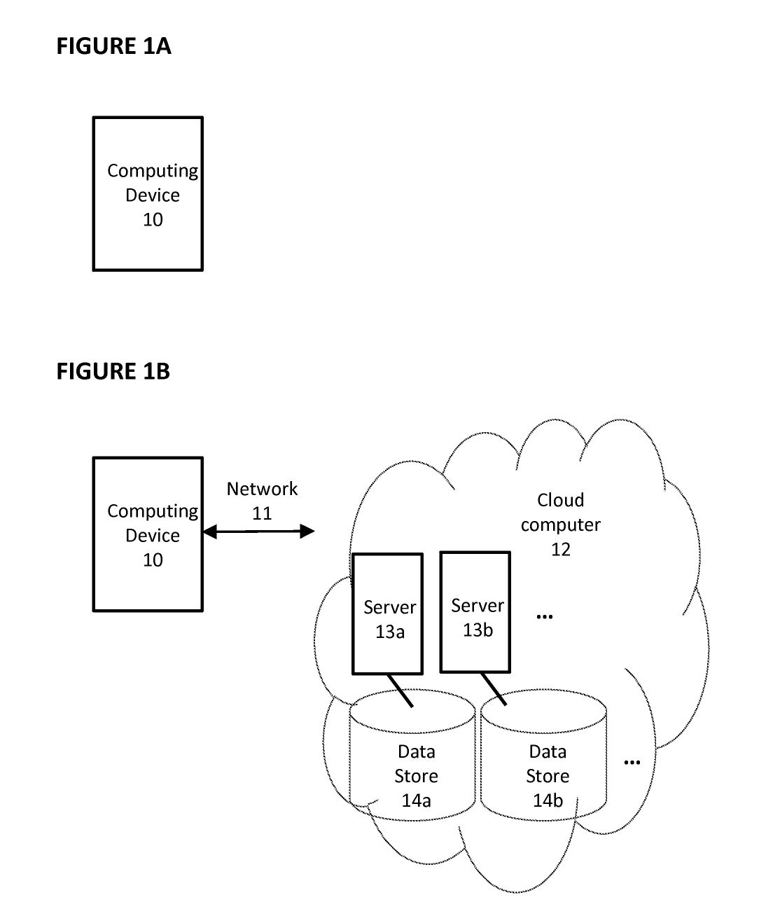

The embodiments described herein utilize one or more computing devices. With reference to FIG. 1A, the embodiments and the algorithms described herein optionally can be implemented in a stand-alone computing device, here shown as computing device 10. Computing device 10 can be a desktop, notebook, server, mobile device, tablet, or any other type of computing device. Computing device 10 comprises one or more processors, memory, and non-volatile storage such as a hard disk drive or flash memory array.

With reference to FIG. 1B, the embodiments and algorithms described herein optionally can be implemented using computing device 10, network 11, and cloud computer 12. In this example, computing device 10 further comprises a network interface, such as an Ethernet port or WiFi interface. Network 11 is a local network, the Internet, or a portion of the Internet. Cloud computer 12 comprises one or more computing devices and associated storage accessible over network 11. For example, cloud computer 12 optionally comprises one or more servers 13a, 13b, etc., each of which is associated with one or more data stores 14a, 14b, etc. Servers 13a, 13b, etc. each comprise one or more processors, memory, non-volatile storage such as a hard disk drive or flash memory array, and a network interface. Data stores 14a, 14b, etc. each comprise a physical storage device (such as a hard disk drive, RAID, NAS or SAN device, flash array, tape library, or other storage device) and database software. Cloud computer 12 optionally runs a Content Management System (CMS.)

In the description that follows, the embodiments and algorithms will be referred to as using cloud computer 12. However, one of ordinary skill in the art will understand that the same functionality can be provided by computing device 10 as shown in FIG. 1A.

### Stakeholder Management Innovations

The current invention includes a plurality of interfaces (e.g. graphical user interface), with different levels of security controls for various types of stakeholders.

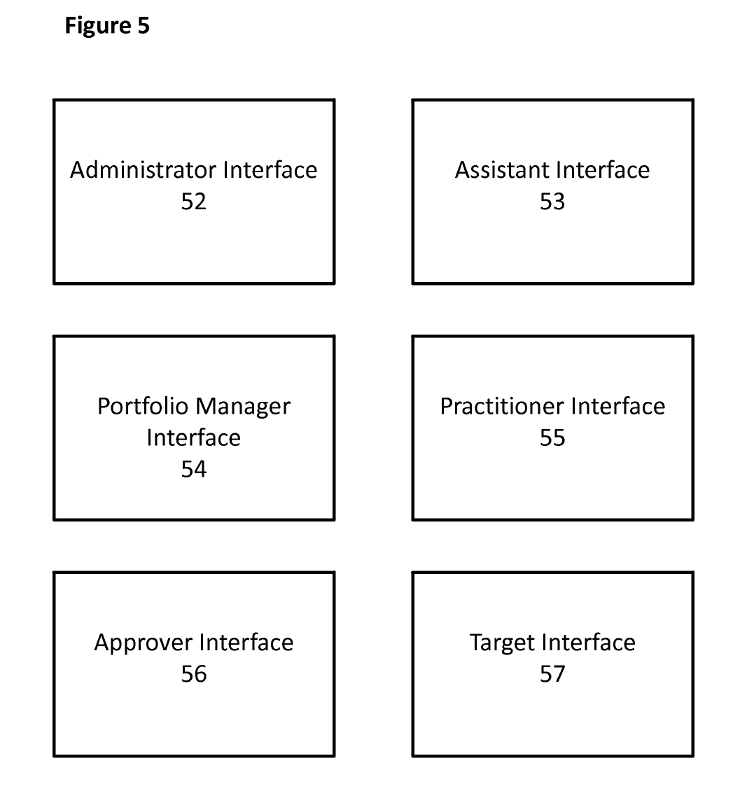

With reference to FIG. 5, the preferred embodiment includes an administrator interface 52, provided by cloud computer 12, that provides complete privileges to add, delete and edit all data fields, tracking reports, system generated messages and configuration settings including the security access permissions for the other users. The administrator is able to establish or terminate access by any stakeholder as per the needs of the specific assessment situation.

The assistant interface 53, provided by cloud computer 12, allows administrative support personnel to edit or configure the subset of data elements and messages that are allowed by the administrator.

The portfolio manager interface 54, provided by cloud computer 12, allows a user who is supervising the deployment of a plurality of assessments to initiate new pre-configured batteries (e.g. bundles of assessments), manage stakeholder lists, track progress, and provide automated and/or portfolio-manager triggered reminders or persuasion to complete or utilize the data produced from the invention.

The practitioner interface 55, provided by cloud computer 12, allows an analyst, manager, consultant, coach, physician or other non-psychometric expert to configure (e.g. construct a battery), deploy, and track a plurality of specific assessments for specific populations and purposes.

Another embodiment of the invention provides an interface for an approver interface 56 (e.g. manager of a given target), provided by cloud computer 12, to confirm a multisource stakeholder list before allowing subsequent assessment.

Finally, the preferred embodiment provides a target interface 57 for a target of an assessment (e.g. entrepreneur), provided by cloud computer 12, to propose nominated stakeholders, including those sourced from social media sources (e.g. Facebook, LinkedIn, Orkut, Google+), contact lists within a computing device (e.g. iPhone, Android device) or sources from within an existing organization (e.g. Microsoft Exchange Server). Subsequently, the invention provides a dashboard for a variety of stakeholders to track the progress of feedback solicitation and acquisition via a dashboard, and trigger automated and/or personalized reminders and pleas for completing the assessments, review recommended solutions, and track subsequent progress against apriori objectives.

Administrator interface 52, assistant interface 53, portfolio manager interface 54, practitioner interface 55, approver interface 56, and target interface 57 optionally can be generated as web pages generated using HTML and other known web languages and viewed on computing device 10 or other computing devices coupled to cloud computer 12. The interactions described above regarding those interfaces can utilize known input devices such as text boxes, radio buttons, links, menus, and other known web devices.

The preferred embodiment provides a graphical user interface (GUI) through the administrator interface 52 for the administrator to drag-and-drop the elements of an entire assessment procedure to include all elements of an assessment procedure—whether driven entirely automatically (e.g. by a target; by a portfolio manager), or semi-automatically. The elements configured include rules for the assessment (e.g. standards/cut scores; start/end dates), system messages triggered by system events (e.g. no stakeholders completed yet; three yet to complete), reminder messages, and final reports and recommendation outputs.

### Measurement Automation Innovations

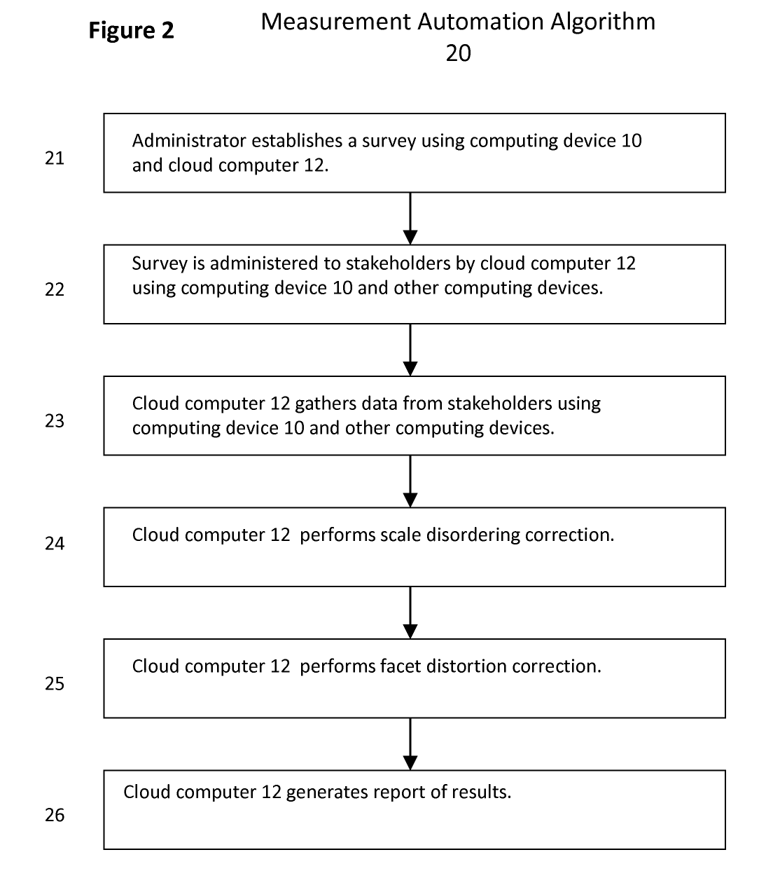

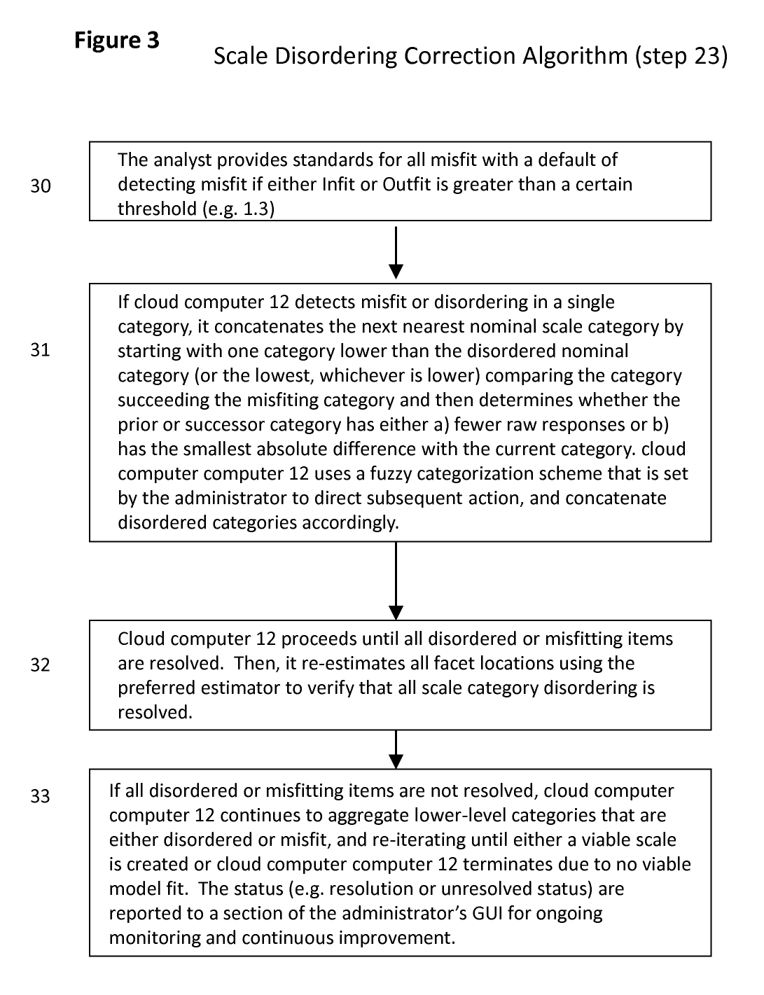

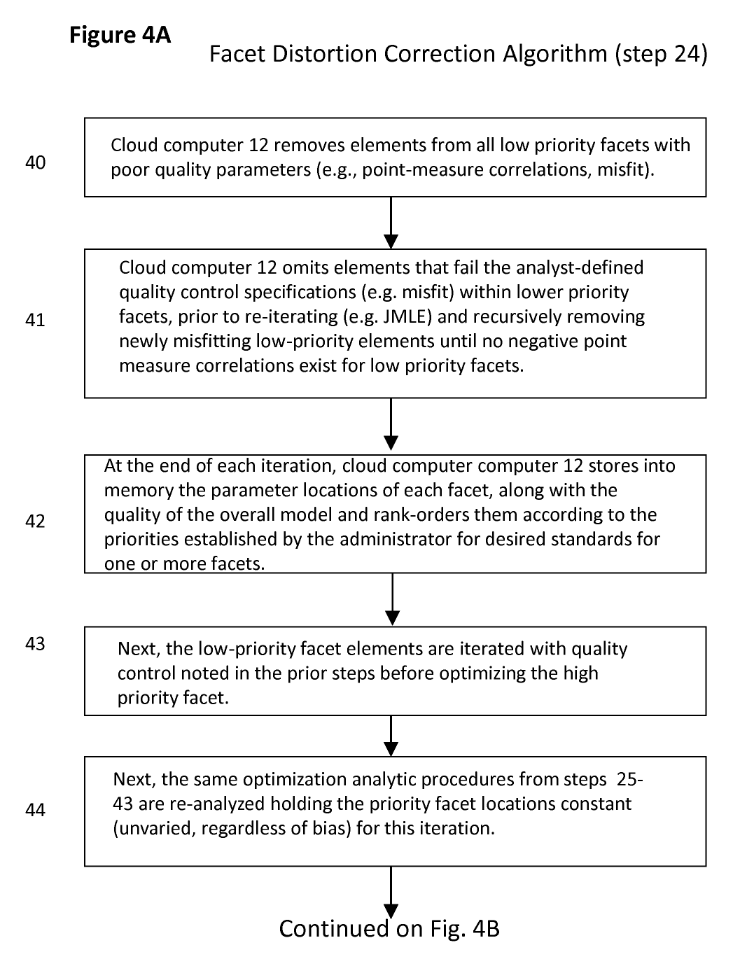

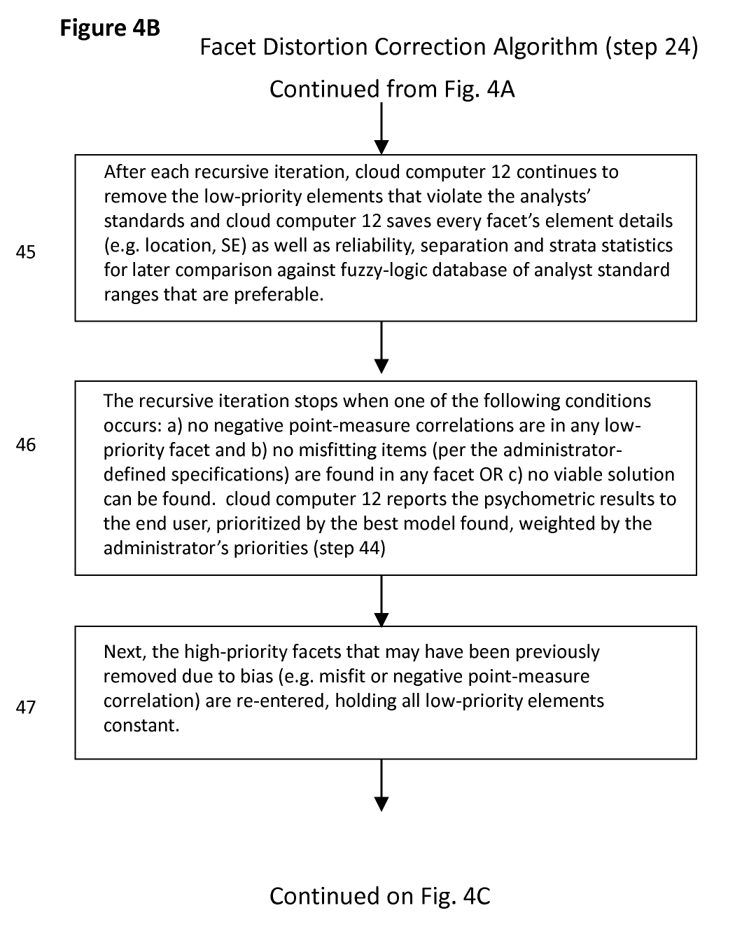

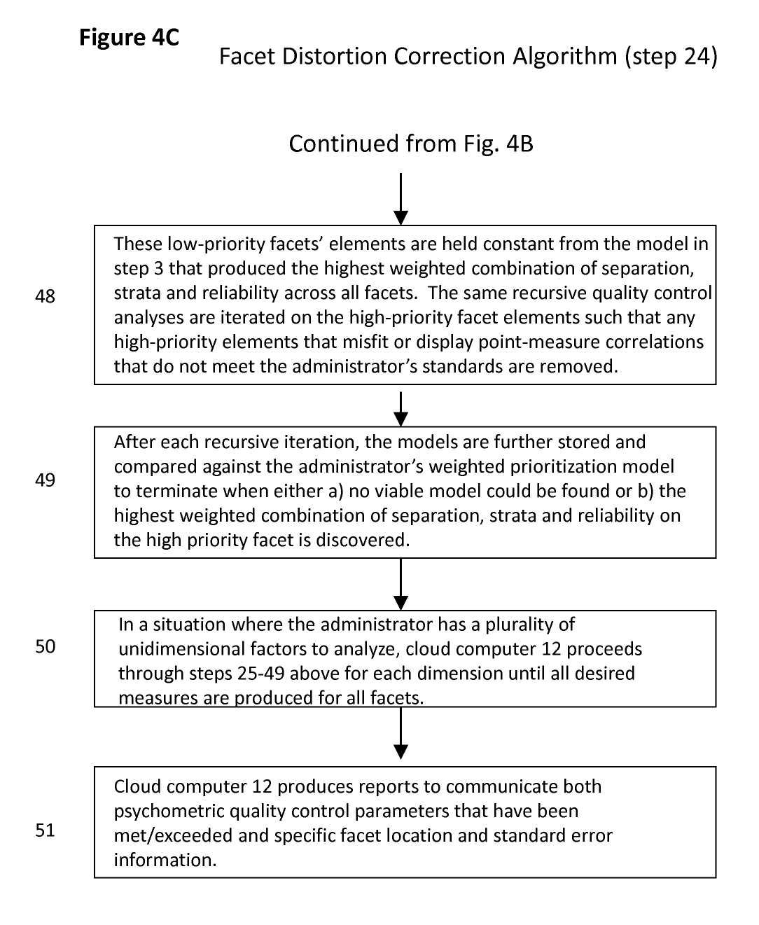

In the preferred embodiment, the automated expert system dynamically calculates psychometric measures based on apriori configurations by the administrator. With reference to FIG. 2, a general description of a measurement automation algorithm 20 is depicted. An administrator establishes a survey using computing device 10 and cloud computer 12 (step 21). The survey is administered to a plurality of users (here, the stakeholders) by cloud computer 12 using computing device 10 and other computing devices (step 22). Optionally, the administrator or Subject Matter Expert estimates item locations (e.g. difficulty) subjectively before empirically calibrating them.

Cloud computer 12 gathers data from the computing devices (i.e., the data from the stakeholders) via computing device 10 and other computing devices (step 23). Cloud computer 12 performs scale disordering correction (step 24), In one embodiment, this is performed using the Many Facet Rasch Model. In other embodiments, the Andrich, Masters, ideal-point, or other known methods can be used instead. Cloud computer 12 performs facet distortion correction (step 25). In one embodiment, this is performed using the Many Facet Rasch Model. In other embodiments, the Andrich, Masters, ideal-point, or other known methods can be used instead. Finally, cloud computer 12 generates report of results of the survey (step 26).

In the preferred embodiment, the system uses the Many Facet Rasch Model known to those skilled in psychometrics but a plurality of other psychometric algorithms may be used. The preferred system iterates element location parameters using a Joint Maximum Likelihood Estimator (JLME) for data with a plurality of facets (e.g. self-ratings with data about contextual facets that may affect the measurement situation); however the invention can iterate using other estimators known to those skilled in the prior art. The preferred automation embodiment uses the following novel methods that provide an expert system that mimics how a professional psychometrician would analyze using prior art technologies, rather than the current invention's fully-automated approach.

1. The system uses Bayesian prior estimates of item and/or other facet locations to deploy the drafted Computer-Adaptive item deployment. The preferred embodiment, however, is to use a fully-crossed set of ratings such that raters and targets are comparable on the same ruler of interest, known to those proficient in the prior Rasch Measurement art. This may be done either with traditional methods whereby all raters receive all items, or with a computer-adaptive approach known in the prior art.

2. Once all stakeholder data are collected, the following expert system algorithms are used to calibrate all facets of interest.

Scale Disordering Correction

Additional detail will now be provided regarding a scale disordering correction algorithm (step 24 in FIG. 2). When a scale is utilized, it ideally is used logically such that a “1” is smaller than a “2” or a “3,” etc. However, people often cannot distinguish between a “1” or a “2,” or they respond irrationally to a specific question. Scale disordering correction can be used to make sure that the scales are logical. For example, if people cannot distinguish between “strongly agree” and “agree,” those categories can be combined to make a logical linear measure.

After a single iteration to estimate facet locations in a given dataset, the algorithm verifies coherent rating scale utilization by ensuring that scales' categories are not disordered and also that they have no significant misfit (e.g. Outlier-weighted misfit statistics). The analyst provides standards for all misfit with a default of detecting misfit if either Infit or Outfit is greater than a certain threshold (e.g. 1.3) (step 30).

Those skilled in the prior art will know that human metrological devices require the scales to be ordered such that lower categories have empirical log-odds units (logit) locations that are smaller than higher categories. Further, those skilled in the prior art will recognize that linear measures cannot deviate materially from a set of theoretical ideals for useful measures (e.g. the Rasch model), and substantive misfitting is a further sign of scale ineffectiveness. If cloud computer 12 detects misfit or disordering in a single category (beyond the thresholds set by the administrator) it proceeds to concatenate the next nearest nominal scale category by starting with one category lower than the disordered nominal category (or the lowest, whichever is lower) comparing the category succeeding the misfiting category and then determines whether the prior or successor category has either a) fewer raw responses or b) has the smallest absolute difference with the current category. Cloud computer 12 uses a fuzzy categorization scheme that is set by the administrator to direct subsequent action, and concatenate disordered categories accordingly (step 31).

Cloud computer 12 proceeds until all disordered or misfitting items are resolved. Then, it re-estimates all facet locations using the aforementioned preferred JML estimator in order to verify that all scale category disordering is resolved (step 32).

In the event that it remains unresolved, cloud computer 12 continues to aggregate lower-level categories that are either disordered or misfit, and re-iterating until either a viable scale is created or cloud computer 12 terminates due to no viable model fit. The status (e.g. resolution or unresolved status) are reported to a section of the administrator's GUI for ongoing monitoring and continuous improvement (step 33). The administrator may also elect to have the system automatically calculate a Principal Components Analysis after every change, in order to either a) verify unidimensionality and proceed; b) detect multidimensionality and attempt separate scale calibration separately; or c) flag multidimensionality for additional administrator inspection and remediation.

Facet Distortion Correction

Additional detail will now be provided regarding a facet distortion correction algorithm (step 25 in FIG. 2). When people make ratings, they have biases. For example, one common type is severity/leniency: some people give more lenient ratings than others do about the same target person being measured. Facet distortion correction ensures that all such biases are corrected, so the resulting measure is fair and accurate. This can include taking into account the type of rater (e.g. bosses are typically more severe than self-ratings), but it can include other facets that might affect a fair measure like the organization, or job type of the person providing the ratings.

Cloud computer 12 remedies any negative point measure correlations that cloud computer 12 detects in one or more facets, as per the administrator's specifications. In the preferred embodiment, the administrator uses a GUI to configure cloud computer 12 to determine one or more facet(s) that are the priority of the analysis in order to optimize the resultant measures. The following three examples are typical, but not exhaustive examples. The first example is where an administrator is mostly interested in calibrating item location elements in a multisource (360). In this case, the administrator can set cloud computer 12 to retain the maximum number of items and prune biased raters relatively liberally (e.g. misfit). The second example is where an administrator is mostly interested in calibrating person locations using known item or other facet element locations. In this situation, cloud computer 12 remains conservative about retaining the maximum possible person locations and prune elements from other facets that distort accuracy and precision in person locations (e.g. biased raters and/or items). A third, but not final example is where an administrator is mostly interested in calibrating rater locations, thereby more liberally removing person, or item locations. Those skilled in the prior art will realize that these three examples, while common, are not exhaustive and a plurality of alternative facets (e.g. rater type; setting) and their respective items may be handled by the current invention in the same way.

Computing device 10 and/or cloud computer 12 start by removing elements from all low priority facets with poor quality parameters (e.g., point-measure correlations correlations, misfit), as those skilled in the prior art will recognize that negative point-measure correlations are performing in the opposite of the desired direction and low but non-zero correlations may be unhelpful to measurement (step 40).

The administrator can configure this feature to specific polarity (e.g. negative) and delta (e.g. expected vs actual) point measure correlation targets. Next, cloud computer 12 omits elements that fail the analyst-defined quality control specifications (e.g. misfit) within lower priority facets, prior to re-iterating (e.g. JMLE) and recursively removing newly misfitting low-priority elements until no negative point measure correlations exist for low priority facets (step 41).

It is within the scope of the invention that, at the discretion of the administrator, cloud computer 12 may be configured to re-verify the lack of negative point-measure correlations in a plurality of elements of a plurality of facets and remove them prior to subsequent facet iteration. At the end of each iteration, cloud computer 12 stores into memory the parameter locations of each facet, along with the quality of the overall model (e.g. total percentage of variance accounted for by the Rasch measures; mean & standard deviation of Outfit and Infit; separation, strata) and rank-orders them according to the priorities established by the administrator for desired standards for one or more facets (step 42). The model (e.g. elements retained in one or more facets) that has the highest weighted combination across all factors desired by the administrator is passed onto the next phase of the current invention's analytic procedure.

Next, the low-priority facet elements are iterated with quality control noted in the prior steps before optimizing the high priority facet (step 43). This set of optimization routines ensure that the model that produces the most useful information is executed, to ensure that overfitting or underfitting is minimized from the earlier iterations. The highest quality facet locations identified for the highest priority facet in steps 40 and 41 are used as a fixed standard, and all prior elements (both fitting and earlier misfitting) from lower priority facets are re-admitted into an estimator (e.g. JMLE) with any scale distortion adjustments concluded from step 40.

Next, the same optimization analytic procedures from steps 25-43 are re-analyzed holding the priority facet locations constant (unvaried, regardless of bias) for this iteration. (step 44).

After each recursive iteration, cloud computer 12 continues to remove the low-priority elements that violate the analysts' standards and cloud computer 12 saves every facet's element details (e.g. location, SE) as well as reliability, separation and strata statistics for later comparison against fuzzy-logic database of analyst standard ranges that are preferable. (step 45).

The recursive iteration stops when one of the following conditions occurs: a) no negative point-measure correlations are in any low-priority facet and b) no misfitting items (per the administrator-defined specifications) are found in any facet OR c) no viable solution can be found. Cloud computer 12 reports the psychometric results to the end user, prioritized by the best model found, weighted by the administrator's priorities (step 46).

Next, the high-priority facet elements that have been previously removed due to bias (e.g. misfit or negative point-measure correlation) are re-entered, holding all low-priority elements constant. (step 47) These low-priority facets' elements are held constant from the model in step 3 that produced the highest weighted combination of separation, strata and reliability across all facets.

The same recursive quality control analyses are iterated on the high-priority facet elements such that any high-priority elements that misfit or display point-measure correlations that do not meet the administrator's standards are removed. (step 48)

After each recursive iteration, the models are further stored and compared against the administrator's weighted prioritization model to terminate when either a) no viable model could be found or b) the highest weighted combination of separation, strata and reliability on the high priority facet is discovered. (step 49)

In a situation where the administrator has a plurality of unidimensional factors to analyze, cloud computer 12 proceeds through the same procedure (steps 25-49 above) for each dimension until all desired measures are produced for all facets. (step 50)

Next, cloud computer 12 produces reports that are common in the prior art to communicate both psychometric quality control parameters that have been met/exceeded and specific facet location and standard error information. (step 51) However, unlike the prior art, the preferred embodiment further automatically tailors feedback for end-users (e.g. leaders, employees, patients). The invention proceeds to a) calculate each person's confidence interval in each of the domains measured to the range of precision established by the analyst; b) look up in a taxonomic database the confidence interval ranges of a plurality of risk-mitigating solutions (e.g. self-development journaling, coaching, mentoring training, books, experiences) whose range of measured uncertainty overlaps with the person's measure; and c) recommends a portfolio of solutions that are targeted at the full-range of the dimension for growth, remediation or gap closure (e.g. leadership development roadmaps; occupational therapy treatment schedules; vitamin and exercise regimens required for Olympic athlete performance; pharmaceutical formularies that differ for moderate, acute or co-morbid conditions).

The preferred embodiment for reporting to end-users who desire the simplest overview of the results is the use of a summary measure of the consistency of the plurality of measures across all dimensions. This can be done with a plurality of methods in the prior art, including but not limited to the use of

$$CpK [ \frac{μ - Standard}{3 σ} ] or [ \frac{standard - μ}{3 σ} ] ,$$

CpM, or the sigma metric known to those skilled in the prior art.

Social Media Solution Harvesting & Verification

A further embodiment of the current invention allows mass-harvesting of developmental or risk-mitigating solutions to be gathered from a plurality of stakeholders that are focused on one or more dimensions of interest. Unlike some prior art inventions that look only at administrator defined solutions that have prior evidence for efficacy, the current invention also allows other stakeholders (e.g. from social media, websites) to propose or suggest solutions that can be tested empirically.

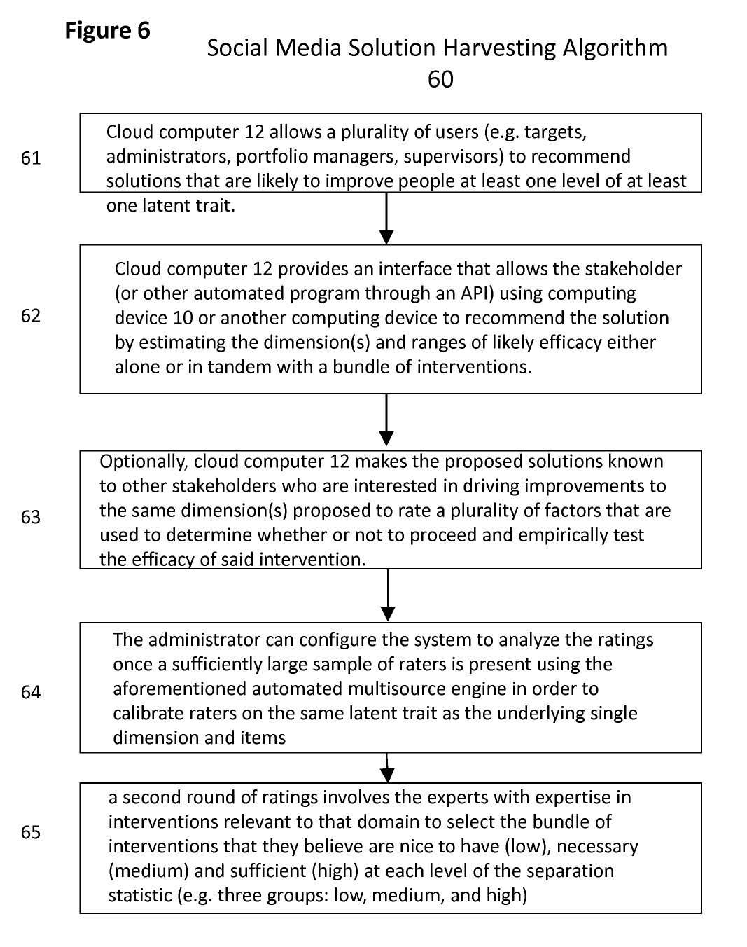

With reference to FIG. 6, a social media harvesting and verification algorithm 60 is depicted. Cloud computer 12 allows a plurality of users (e.g. targets, administrators, portfolio managers, supervisors) to recommend solutions that are likely to improve people at least one level of at least one latent traits (step 61). Cloud computer 12 provides an interface that allows the stakeholder (or other automated program through an API) using computing device 10 or another computing device to recommend the solution by estimating the dimension(s) and ranges of likely efficacy either alone or in tandem with a bundle of interventions (step 62).

Optionally, cloud computer 12 makes the proposed solutions known to other stakeholders (e.g. senior leaders) who are interested in driving improvements to the same dimension(s) proposed to rate a plurality of factors that are used to determine whether or not to proceed and empirically test the efficacy of said intervention (step 63). Factors may include such aspects of quality, cost, scalability, speed, relative utility, or cultural appropriateness, but other factors are also within the spirit and scope of the current invention. The administrator can configure the system to analyze the ratings once a sufficiently large sample of raters is present using the aforementioned automated multisource engine in order to calibrate raters on the same latent trait as the underlying single dimension and items (step 64). Once calibrated, a second round of ratings involves the experts with expertise in interventions relevant to that domain to select the bundle of interventions that they believe are nice to have (low), necessary (medium) and sufficient (high) at each level of the separation statistic (e.g. three groups: low, medium, and high) (step 65).

The preferred embodiment uses a Graphical User Interface (GUI) for step 63 to allow the person recommending the solution to drag the known, calibrated solutions into a prioritized grouping. For example, they may rate the solution as nice, necessary and sufficient (or whatever other rating scale preferred for the specific application) so that it is easy to ensure that only solutions that are within the confidence interval for that specific region of the scale are chosen as the recommended bundle. In the end, the system reports the final information textually and graphically for use in a plurality of medical, business, sports, and educational applications.

Further, the current invention makes a number of novel solutions that improve the cycle time, and quality of metrology and development interventions:

### Cycle Time Improvement Claims

Session-Based Item Seed & Iterative Calibration.

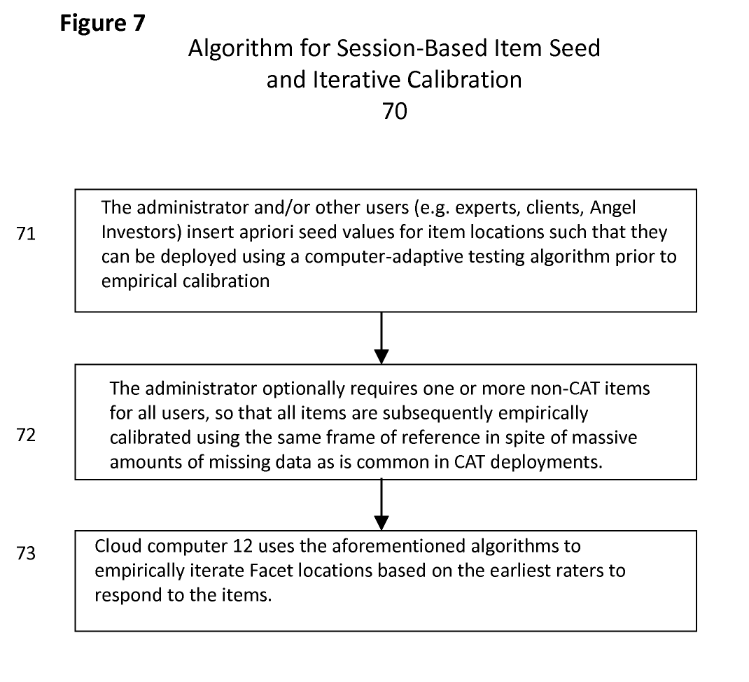

With reference to FIG. 7, an algorithm for session-based item seed and iterative calibration 70 is disclosed. Algorithm 70 is performed by cloud computer 12. The administrator and/or other users (e.g. experts, clients, Angel Investors) insert apriori seed values (e.g. log-odds units) for item locations such that they can be deployed using a computer-adaptive testing algorithm prior to empirical calibration (step 71). The administrator optionally requires one or more mandatory, non-CAT items for all users, so that all items are subsequently empirically calibrated using the same frame of reference in spite of massive amounts of missing data as is common in CAT deployments (step 72). An apriori seed value by different stakeholders for different facets is used. For example, a domain expert may estimate, using a Bayesian approach, the location of items that are not yet empirically calibrated. Further, a given target may have an apriori Bayesian estimate for a given target (e.g. rating of an entrepreneur by a Venture Capitalist) for a given target prior to administering any items. Next, cloud computer 12 uses the aforementioned algorithms to empirically iterate Facet locations based on the earliest raters to respond to the items (step 73). In this preferred embodiment, better information is collected more efficiently than inventions in the prior art by using the combined total of prior rater's person location estimates for the target as the seed value for any new raters, such that the subsequent seed values become successively closer to the empirical values that would be ultimately available with large samples.

This aspect of the invention improves on the prior art in three ways. First, it enables extremely rapid item development by beginning with new items that do not require 200+ subjects and many months to calibrate items as is typical in prior art CAT applications. Second, with each automated iteration that uses Bayesian prior estimates together with subsequent empirically calibrated item locations, a given rater will have a higher probability that the items they respond to will be progressively closer to the target person's location so as to reduce the need for many more items. Third, the preferred embodiment makes much more efficient use of scarce raters by ceasing to ask raters to rate dimensions that already have sufficiently small standard errors. No prior art invention can conserve on scarce raters in this way.

Historical Person Seed Values.

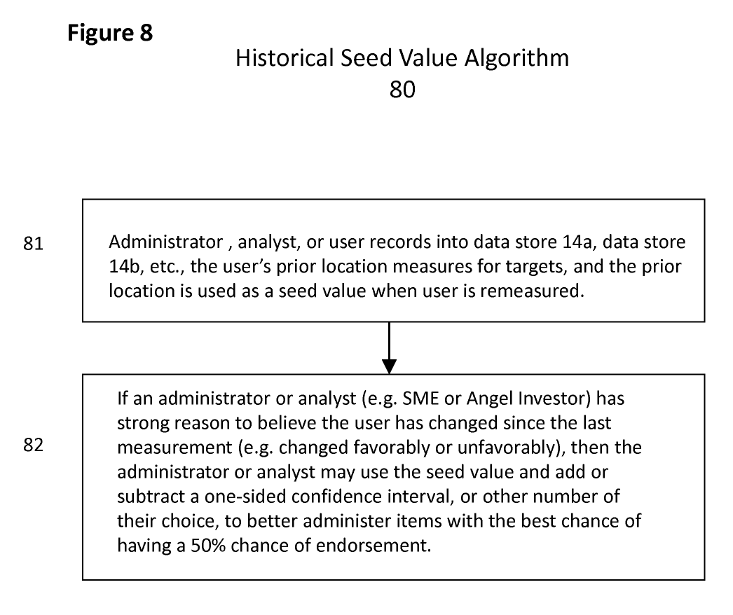

With reference to FIG. 8, the invention includes the option of the administrator, analyst, or user recording into data store 14a, data store 14b, etc., the user's prior location measures for targets, and the prior location is used as a seed value when the user is remeasured (step 81). This improves the probability that the next item delivered by the CAT system will be relatively close to the current person location, thereby improving the amount of information that will likely be collected upon this remeasurement. Further, if the administrator or analyst (e.g. SME or Angel Investor) has strong reason to believe the user has changed since the last measurement (e.g. changed favorably or unfavorably), then the administrator or analyst may use the seed value and add or subtract a one-sided confidence interval, or other number of their choice to better administer items with the best chance of having a 50% chance of endorsement (step 82), thereby maximizing psychometric information produced by the earliest items deployed by the CAT. Those skilled in the prior art will recognize that all measurement has the best information when a person has a 50% probability of answering an item correctly (e.g. knowledge test) or having it endorsed favorably (e.g. reputation).

This invention improves on prior art innovations by having an administrator estimate an apriori location by combining empirical and model-based information (e.g. likelihood of development after training) to more efficiently focus the selection of CAT-based items that are likely to be close to the location of the person to be measured. This has the highest benefit for the most extreme (e.g. high or low) persons who would otherwise have to answer more questions that are far away from their location (e.g. in the middle of the scale) with prior art CAT, CBT or paper-and-pencil embodiments.

Expert System Tradeoff Analysis: Depth & Brevity.

The current invention further includes a number of claims about altering the level-of-analysis of the measurement to balance complex tradeoffs between reducing the time it takes to administer items, and maximizing useful information. Experts skilled in the prior art will recognize that more scales will usually produce more information but also are more laborious for raters, and therefore may be more likely to have missing data or cause fatigue with over-surveying.

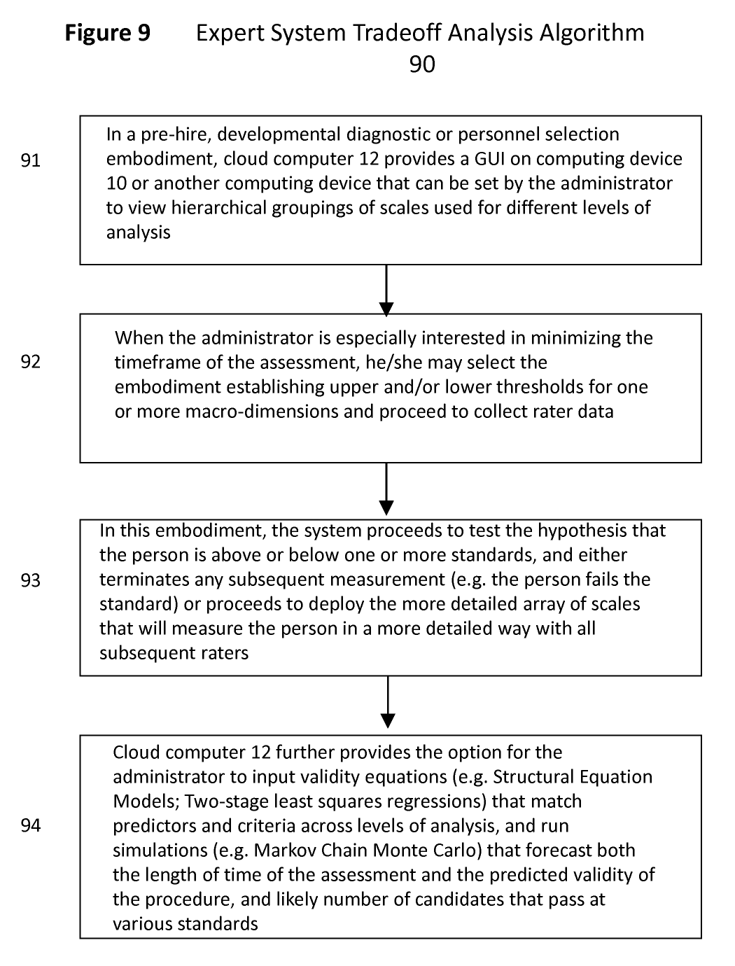

With reference to FIG. 9, an expert system tradeoff analysis algorithm 90 is depicted. In a pre-hire, developmental diagnostic or personnel selection embodiment, cloud computer 12 provides a GUI on computing device 10 or another computing device that can be set by the administrator to view hierarchical groupings of scales used for different levels of analysis (step 91). When the administrator is especially interested in minimizing the timeframe of the assessment, he/she may select the embodiment establishing upper and/or lower thresholds for one or more macro-dimensions and proceed to collect rater data (step 92). In this embodiment, the system proceeds to test the hypothesis that the person is above or below one or more standards, and either terminates any subsequent measurement (e.g. the person fails the standard) or proceeds to deploy the more detailed array of scales that will measure the person in a more detailed way with all subsequent raters (step 93). Cloud computer 12 further provides the option for the administrator to input equations that establish predictor-criterion relationships (e.g. Two-stage least squares regressions) and run simulations (e.g. Markov Chain Monte Carlo) that forecast both the length of time of the assessment and the predicted validity of the procedure, and likely number of candidates that pass at various standards (step 94).

This allows the administrator to balance multiple goals to a) minimize the time of administration by using scales that are macro-versions of micro scales that might otherwise be used; b) maximize the validity of the assessments that are used; and c) ensure sufficient candidate pools will be available with the resultant decisions (e.g. in a selection embodiment). For example, instead of administering two assessments such as attention to detail, and punctuality, the administrator may select a conscientiousness scale that is hierarchically at a higher level of analysis, thereby significantly reducing total administration time, but only losing a trivial amount of predictive validity.

Iterative Drill-Down-Detail.

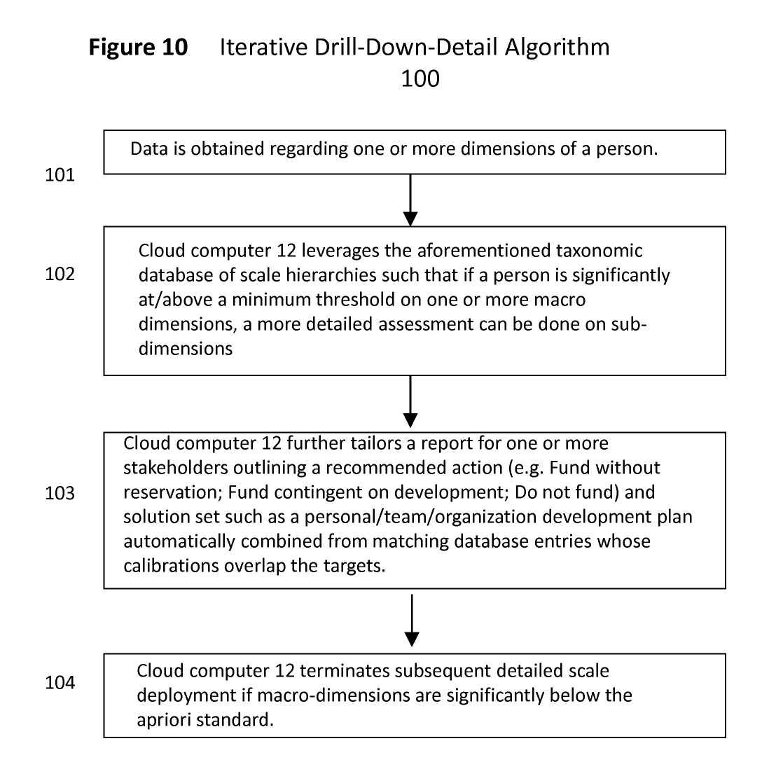

With reference to FIG. 10, an iterative drill-down-detail algorithm 100 is disclosed. The current invention can further be used by those familiar with a hypothesis testing mode known in the prior art for CAT-based unproctored internet-based testing. People performing due diligence (e.g. Private Equity, Hiring Managers, Venture Capitalists) can verify that one or more dimensions are at or above a previously established threshold before proceeding to take the time to interview a candidate or listen to a “pitch”. First, data is obtained regarding one or more dimensions of a person (step 101). Then, uniquely, cloud computer 12 leverages the aforementioned taxonomic database of scale hierarchies such that if a person is significantly at/above a minimum threshold on one or more macro dimensions, a more detailed assessment can be done on sub-dimensions (step 102). This further allows for more detailed information at lower levels of analysis that are helpful for further probing in interviews, and for planning portfolios of development or other risk-mitigating actions specifically targeted to each person. Cloud computer 12 further tailors a report for one or more stakeholders outlining a recommended action (e.g. Fund without reservation; Fund contingent on development; Do not fund) and solution set such as a personal/team/organization development plan automatically combined from matching database entries whose calibrations overlap the targets (step 103). But importantly, cloud computer 12 terminates subsequent detailed scale deployment if macro-dimensions are significantly below the apriori standard (step 104), thereby saving significant time for all stakeholders in contrast with inventions in the prior art.

Fuzzy Surprise Scrutiny.

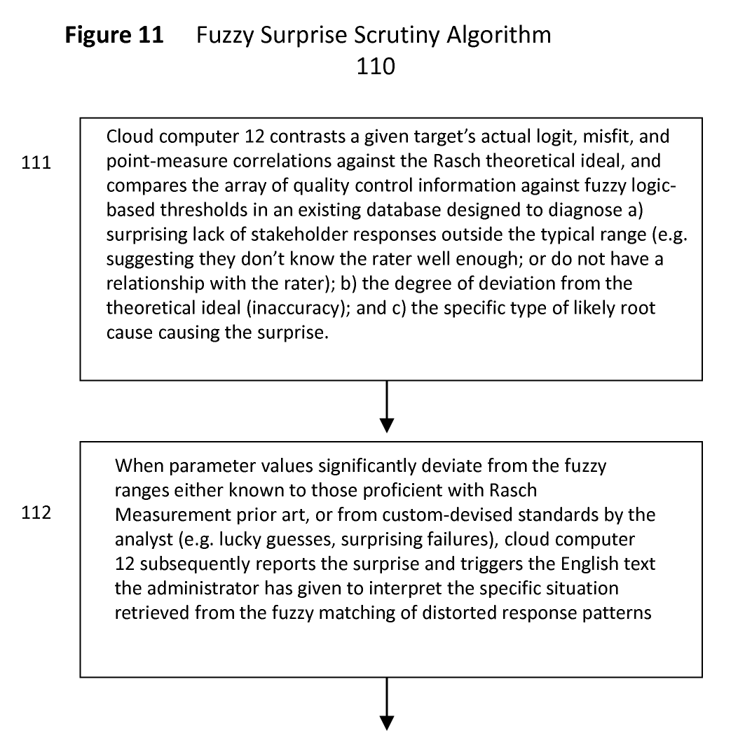

FIG. 11 depicts a fuzzy surprise scrutiny algorithm 110. The current invention further uses hybridized weighted quality control procedures to uncover and report hidden surprises for further due diligence. Cloud computer 12 contrasts a given target's actual logit, misfit, and point-measure correlations against the Rasch theoretical ideal, and compares the array of quality control information against fuzzy logic-based thresholds in an existing database designed to diagnose a) surprising lack of stakeholder responses outside the typical range (e.g. suggesting they don't know the rater well enough; or do not have a relationship with the rater); b) the degree of deviation from the theoretical ideal (inaccuracy); and c) the specific type of likely root cause causing the surprise. (step 111). When parameter values significantly deviate from the fuzzy ranges either known to those proficient with Rasch Measurement prior art, or from custom-devised standards by the analyst (e.g. lucky guesses, surprising failures), cloud computer 12 subsequently reports the surprise and triggers the English text the administrator has given to interpret the specific situation retrieved from the fuzzy matching of distorted response patterns (step 112). In this way, the current invention further saves key stakeholders (e.g. VCs, Hiring Managers) time by focusing limited time only on those areas the expert system identifies as surprising and worth further investigation.

Rater Participation Enhancement.

One serious problem with prior art inventions is that raters who are invited to a multisource survey often do not begin, and do not complete the desired survey. Without data, no analysis can be performed so this is a serious limitation with prior art technologies.

a. Commitment Technology.

A preferred embodiment of the current invention is to allow raters to make public, active and voluntary commitments to invest a particular amount of time in giving more or less feedback (or none at all). In contrast with prior art innovations, cloud computer 12 provides a GUI with a calendar facility to invite prospective raters to make a specific commitment to a timeframe to give feedback. Consistent with prior art from Social Psychology (e.g. Cialdini, 2001), these small but active and voluntary commitments will improve the probability that the rater will complete the agreed-upon feedback/measurement task requested so that they keep their promise and minimize any cognitive dissonance, at least for raters who would like to help the target get useful feedback. Experts in prior art multisource rating will recognize that current technologies provide a system-generated time allotment for completion of specific scales, tests and batteries, and no prior art inventions are able to adjust based on the availability of the rater. Uniquely, this invention allows the administrator to request raters to commit an amount of time that they will have available to complete the assessment accurately and conscientiously, and then adjust the psychometric procedure to maximize their time and the information gleaned.

b. Automated Segmentation Suggestions.

The preferred embodiment of this invention estimates the total time it will likely take to complete all scales, using either historical data about the mean scale completion time, or the analyst's estimate and suggests to the end user that they break rating task into smaller chunks of time if greater than a certain threshold set by the analyst (e.g. 45 minutes). The system then provides a hyperlink to a web-based calendar, or downloadable file (e.g. Microsoft Outlook Invitation) with automated reminders available with systems in the prior art.

c. Commitment Forecast & Mitigation.

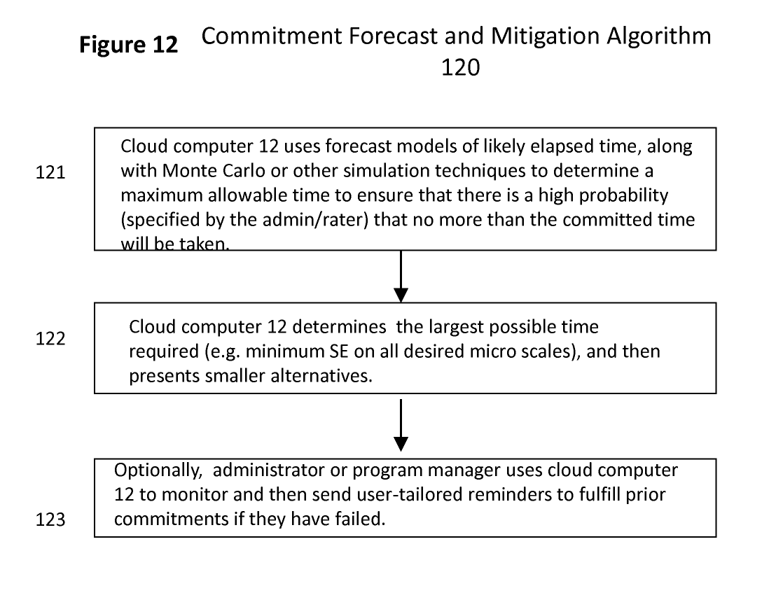

FIG. 12 depicts a commitment forecast and mitigation algorithm 120. In the preferred embodiment, cloud computer 12 aggregates the data about stakeholder commitments across all raters and forecasts the likely date when all data will be collected, for remediation by a plurality of stakeholders (e.g. analyst, target). In one variation, no time limits are set. In another variation, cloud computer 12 does not allow commitments to occur outside the deadline dates set by the analyst, target, or other stakeholder (e.g. VC or Angel). First, cloud computer 12 uses forecast models of likely elapsed time, along with Monte Carlo or other simulation techniques to determine a maximum allowable time to ensure that there is a high probability (specified by the admin/rater) that no more than the committed time will be taken (step 121). Cloud computer 12 determines the largest possible time required (e.g. minimum SE on all desired micro scales), and then presents smaller alternatives (step 122). Such mass-customized rater commitments may further improve quality and completion rates (more likely to fulfill promise in that sitting when they've already committed). Example opportunities to make small public, active and voluntary commitments include the following:

Will you please give me feedback?
Yes-~40 min survey
Yes-~30 min survey
Yes-~20 min survey
Yes-~10 min survey
No thanks

Optionally, the administrator or program manager uses cloud computer 12 to monitor and then send user-tailored reminders to fulfill prior commitments if they have failed (step 123), improving the chances of actual response rates that are a serious issue known to vex experts in the prior art.

Target by Rater Optimization.

Experts in the prior art are aware that existing multisource assessments technologies have less-than-effective functionality in helping to managing the raters who are asked to participate to contribute to an assessment (e.g. of a CEO). Prior art solutions use an interface whereby the administrator is able to establish minimum or maximum numbers of raters per category, and/or to enable a third party approval (e.g. manager) prior to item administration. Prior art solutions are unable to dynamically adjust the specific measurement strategy as new information is gleaned, to maximize the chance of consistently good information across all desired scales for a given target, and across all targets of interest.

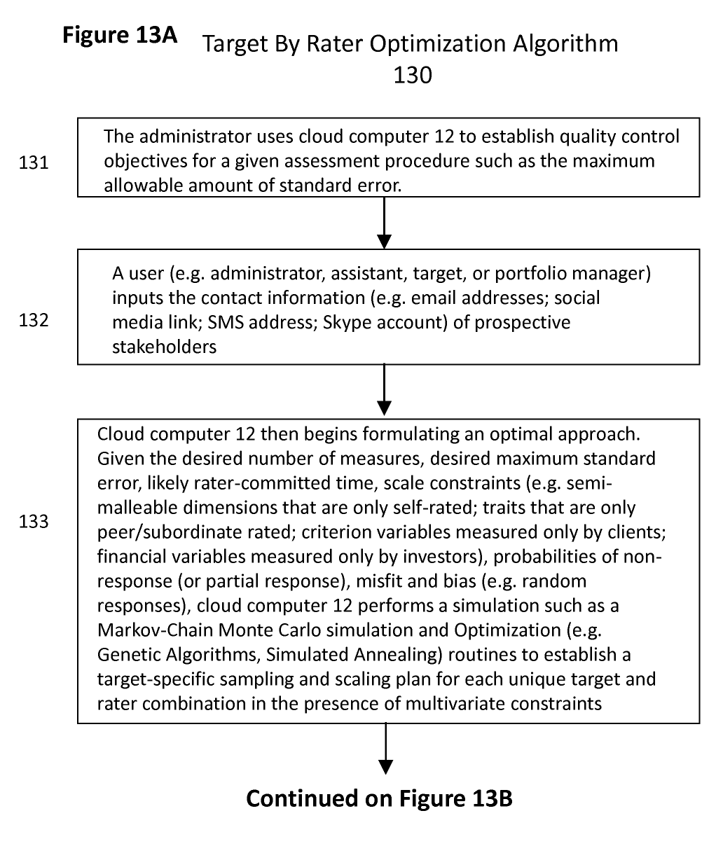

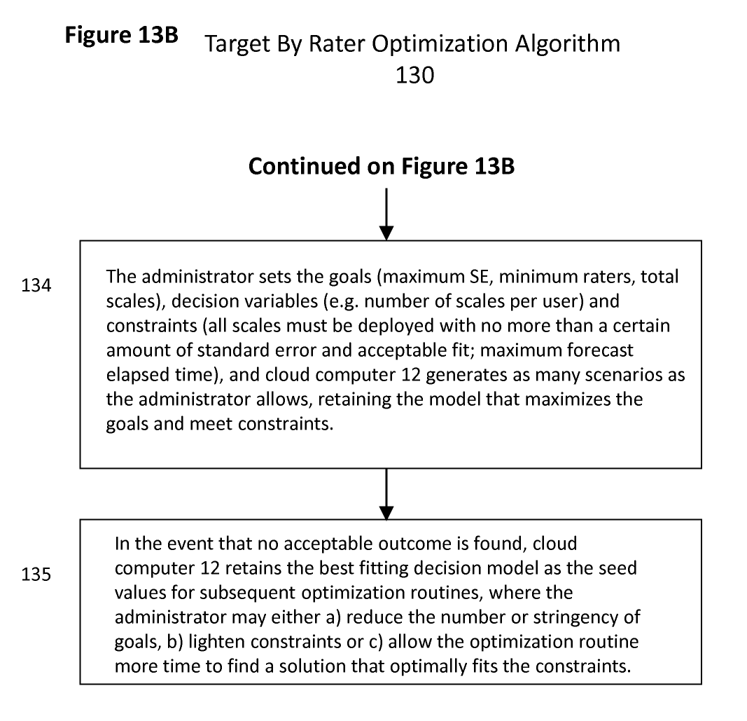

FIGS. 13A and 13B depict a target by rate optimization algorithm 130. The administrator uses cloud computer 12 to establish quality control objectives for a given assessment procedure such as the maximum allowable amount of standard error (step 131). A user (e.g. administrator, assistant, target, or portfolio manager) inputs the contact information (e.g. email addresses; social media link; SMS address; Skype account) of prospective stakeholders (step 132). Cloud computer 12 then begins formulating an optimal approach. Given the desired number of measures, desired maximum standard error, likely rater-committed time, scale constraints (e.g. semi-malleable dimensions that are only self-rated; traits that are only peer/subordinate rated; criterion variables measured only by clients; financial variables measured only by investors), probabilities of non-response (or partial response), misfit and bias (e.g. random responses), cloud computer 12 performs a simulation such as a Markov-Chain Monte Carlo simulation and Optimization (e.g. Genetic Algorithms, Simulated Annealing) routines to establish a target-specific sampling and scaling plan for each unique target and rater combination in the presence of multivariate constraints (step 133). The administrator sets the goals (maximum SE, minimum raters, total scales), decision variables (e.g. number of scales per user) and constraints (all scales must be deployed with no more than a certain amount of standard error and acceptable fit; maximum forecast elapsed time), and cloud computer 12 generates as many scenarios as the administrator allows, retaining the model that maximizes the goals and meet constraints (step 134). In the event that no acceptable outcome is found, cloud computer 12 retains the best fitting decision model as the seed values for subsequent optimization routines, where the administrator may either a) reduce the number or stringency of goals, b) lighten constraints or c) allow the optimization routine more time to find a solution that optimally fits the constraints (step 135). In one embodiment, the system may allow a single rater to be assigned only a subset of scales with apriori known calibration values to lower time burdens on the raters, but assuring that minimum quality and standard error thresholds are met.

Automated Optimized Planning.

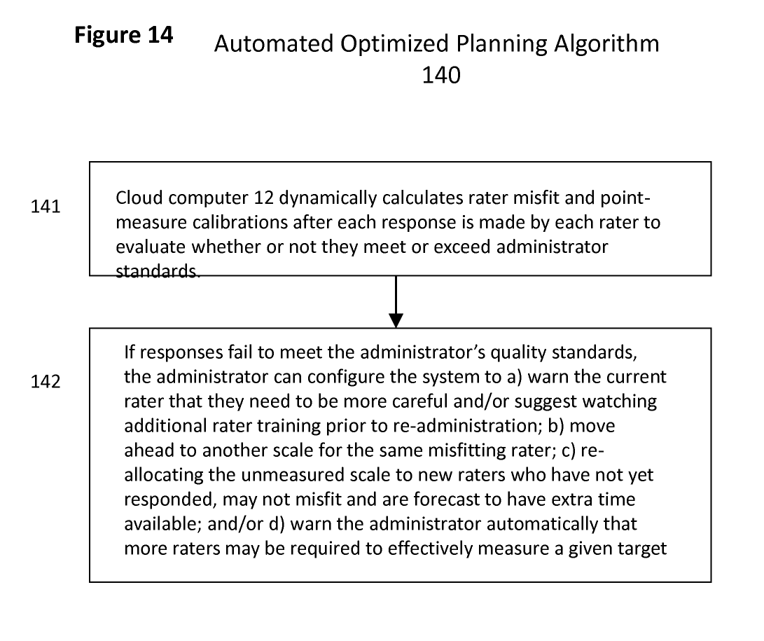

The preferred embodiment dynamically adjusts the optimized forecast plan as new data are collected. FIG. 14 depicts an automated optimized planning algorithm 140. Cloud computer 12 dynamically calculates rater misfit and point-measure calibrations after each response is made by each rater to evaluate whether or not they meet or exceed administrator standards (step 141). If responses fail to meet the administrator's quality standards, the administrator can configure the system to a) warn the current rater that they need to be more careful and/or suggest watching additional rater training prior to re-administration; b) skip ahead to another scale for the same misfitting rater; c) re-allocating the unmeasured scale to new raters who have not yet responded, and are forecast to have extra time available; and/or d) warn the administrator automatically that more raters may be required to effectively measure a given target (step 142).

Multiple Hurdles & Predicted Seeds.

One embodiment of the current invention includes a plurality of factors to be measured where some must be above or below a threshold prior to subsequent assessments being administered. Those knowledgeable in the prior art will recognize that multiple hurdle pre-hire or high-potential employee selection includes situations such that the lower cost and/or faster scales are administered first, especially in an unproctored environment and later, more expensive tests can be administered to a smaller subset of test takers. This prior art innovation saves money and also reduces the total testing time taken by minimizing the numbers of tests that are taken at the second or subsequent test administrations.

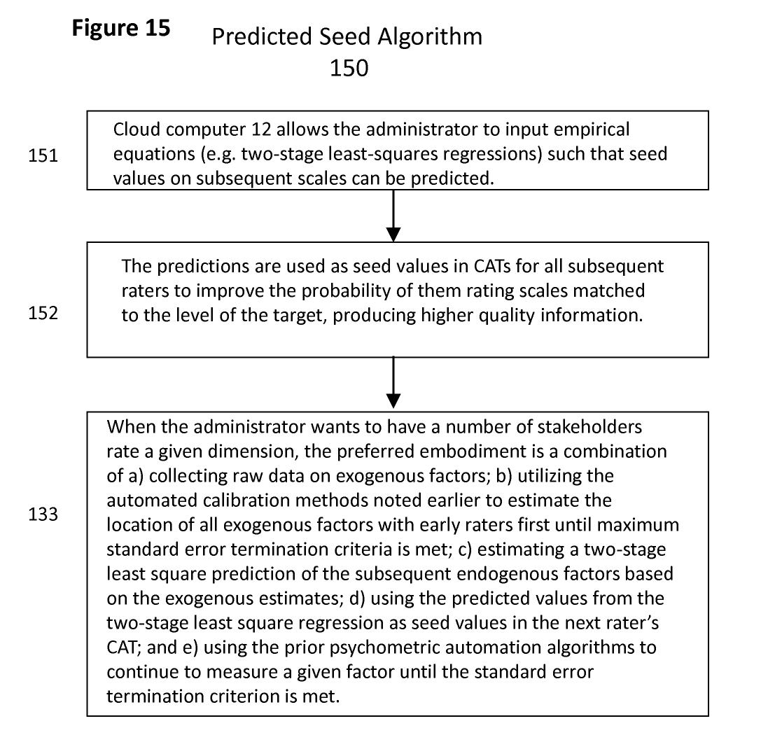

The current invention adds to the prior art by using proxies to further reduce assessment burden. FIG. 15 depicts a predicted seed algorithm 150. Cloud computer 12 allows the administrator to input empirical equations (e.g. two-stage least-squares regressions) such that seed values on subsequently re-administered scales can be predicted (step 151). These predictions, in turn, are used as seed values in CATs for all subsequent raters (e.g. panel interviewers) to improve the probability of them rating scales matched to the level of the target, producing higher quality information (step 152). When the administrator wants to have a number of stakeholders rate a given dimension, the preferred embodiment is a combination of the administrator a) collecting raw data on exogenous factors; b) utilizing the automated calibration methods noted earlier to estimate the location of all exogenous factors with early raters first until maximum standard error termination criteria is met; c) estimating a two-stage least square prediction of the subsequent endogenous factors based on the exogenous estimates; d) using the predicted values from the two-stage least square regression as seed values in the next rater's CAT; and e) using the prior psychometric automation algorithms to continue to measure a given factor until the standard error termination criterion is met (step 153).

Relevant Dimensions Just in Time.

Prior art inventions only focus the assessment process on task or job specific areas, but not concomitantly on the lifecycle of a process whose antecedents may be qualitatively different, even for the same job or task at different points in time. For example, in entrepreneurship, the customer development process contains many hypothesis generation, testing, iteration and pivot tasks around first the business model's a) problem; b) solution; c) demand creation and d) company building (Blank & Dorf, 2012). The activities in each phase, for example, are substantially different and the antecedents (e.g. attributes of the entrepreneur, market factors) may be significantly different, or differentially weighted for effective predictions.

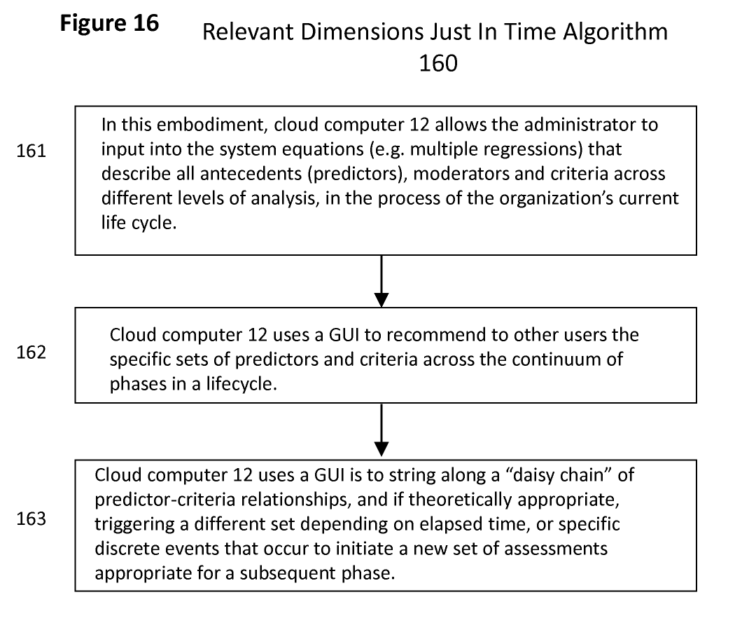

FIG. 16 depicts a relevant dimensions just in time algorithm 160. In this embodiment, cloud computer 12 allows the administrator to input into the system equations (e.g. multiple regressions) that describe all antecedents (predictors), moderators and criteria across different levels of analysis, in the process of the organization's current life cycle (step 161). In this way, cloud computer 12 uses a GUI to recommend to other users the specific sets of predictors and criteria across the continuum of phases in a lifecycle (step 162). Cloud computer 12 uses a GUI is to string along a “daisy chain” of predictor-criteria relationships, and if theoretically appropriate, triggering a different set depending on elapsed time, or specific discrete events that occur to initiate a new set of assessments appropriate for a subsequent phase (step 163). For example, the preferred embodiment is for private equity investors to use the invention for entrepreneur due diligence only measuring the predictors that are antecedents to the specific funding round success of that business phase. Angel Investors, or Venture Capitalists focused on seed investments will focus for example, on an entrepreneur's ability to generate a minimum viable product that customers want to buy whereas in later phases they are interested in the same leader's ability to scale the firm.

This aspect of the invention focuses a smaller subset of possible predictors thereby keeping the assessment process especially short and precise such that is useful “just in time” for both the investor and the target (e.g. entrepreneur). Further, the preferred embodiment stores earlier assessment values of immutable dimensions (e.g. personality, cognitive ability) to be “reused” on subsequent administrations and forecasts, further saving time but providing further variance accounted for in risk detection.

Anchored, Dynamic & Randomized New Item Calibration Sets.

One embodiment that the administrator can select is to calibrate a new set of items using a Computer-Based approach that includes a plurality of items with Bayesian-derived logit levels, or pre-calibrated logits along with a finite bundle of qualitatively different items about the same dimension. Those skilled in the prior art will recognize that an item linking strategy is used to minimize the number of items a given rater must face in a Computer-Based assessment, in order to calibrate a much larger set of items.

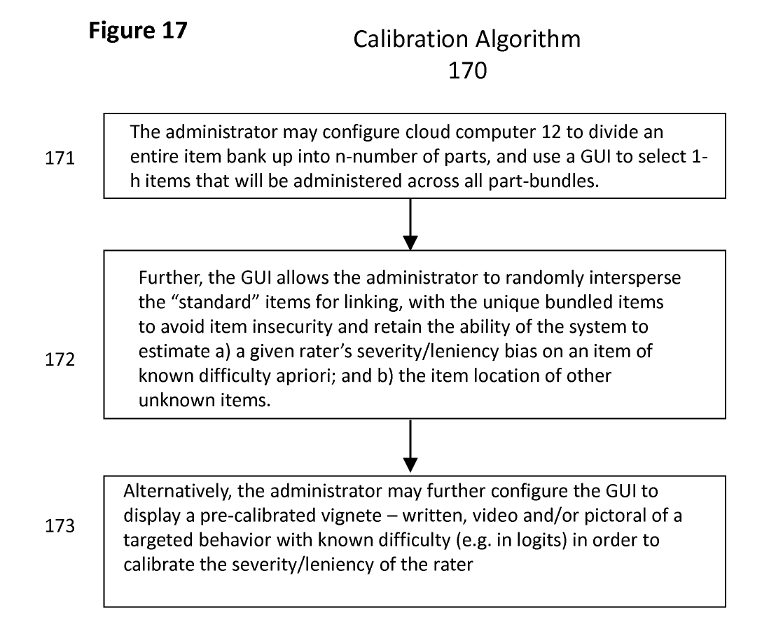

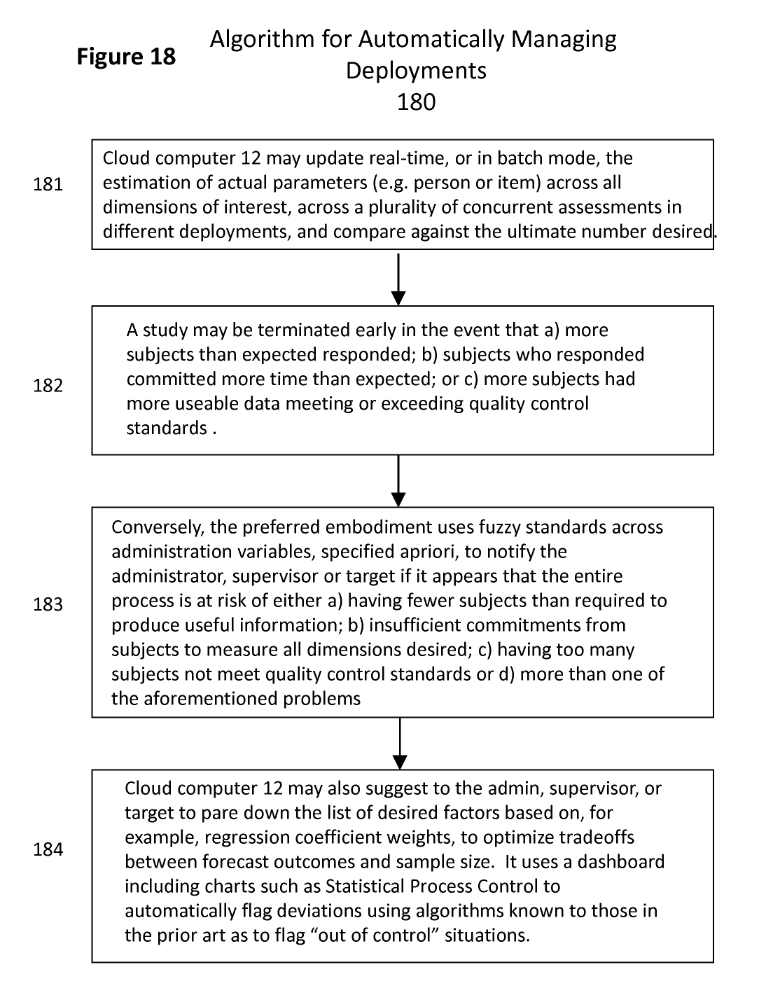

FIG. 17 depicts a calibration algorithm 170. The administrator may configure cloud computer 12 to divide an entire item bank up into n-number of parts, and use a GUI to select 1-h items that will be administered across all part-bundles (step 171). Further, the GUI allows the administrator to randomly intersperse the “standard” items for linking, with the unique bundled items to avoid item insecurity and retain the ability of the system to estimate a) a given rater's severity/leniency bias on an item of known difficulty apriori; and b) the item location of other unknown items (step 172). Alternatively, the administrator may further configure the GUI to display a pre-calibrated vignette—written, video and/or pictoral of a targeted behavior with known difficulty (e.g. in logits) in order to calibrate the severity/leniency of the rater (step 173).

Automatically Managing Deployments.

The preferred embodiment of the solution supports the administrator to automatically managing multiple assessment deployments simultaneously with expert system logic. It uses fuzzy logic to supervise the data collection process and continuously adjust the deployment of scales, session-based standard errors (e.g. for a particular rater), and consequently automate fully-aggregated person and/or item location estimates in the service of ultimate goals established by the administrator.

FIG. 18 depicts an algorithm for automatically managing deployments (180). Cloud computer 12 may update real-time, or in batch mode, the estimation of actual parameters (e.g. person or item) across all dimensions of interest, across a plurality of concurrent assessments in different deployments, and compare against the ultimate number desired (step 181). A study may be terminated early in the event that a) more subjects than expected responded; b) subjects who responded committed more time than expected; or c) more subjects had more useable data meeting or exceeding quality control standards (step 182). Conversely, the preferred embodiment uses fuzzy standards across administration variables, specified apriori, to notify the administrator, supervisor or target if it appears that the entire process is at risk of either a) having fewer subjects than required to produce useful information; b) insufficient commitments from subjects to measure all dimensions desired; c) having too many subjects not meet quality control standards or d) more than one of the aforementioned problems (step 183). Cloud computer 12 may also suggest to the admin, supervisor, or target to pare down the list of desired factors based on, for example, regression coefficient weights, to optimize tradeoffs between forecast outcomes and sample size. It uses a dashboard including charts such as Statistical Process Control to automatically flag deviations using algorithms known to those in the prior art as to flag “out of control” situations (step 184).

The invention further improves the quality of the measurement, feedback, and evaluation in numerous ways:

GUI-Based Rater Bias Prevention.

Prior art inventions include the use of a slider bar to avoid response sets and force raters to cognitively process the rating at a deeper level (e.g. Hesketh, Pryor, Gleitzman & Hesketh, 1988). But prior art inventions typically start with a “slider bar” that is already in the center of the line that is used to solicit feedback, exacerbating the central tendancy bias known to those skilled in the prior art for distorting measurement information (e.g. US2012/8,282,397B2). Further, prior art inventions use a numerical feedback display to assist the rater in inputting raw data but display the numerical feedback in a separate area of the GUI that is inefficient, especially for mobile devices with restricted screen real-estate.

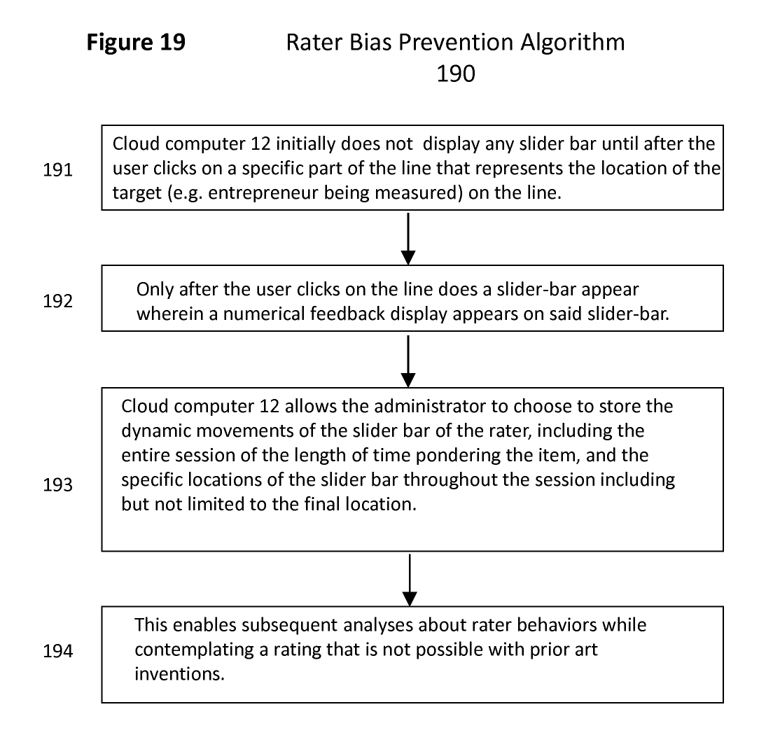

FIG. 19 depicts a rater bias prevention algorithm 190. Cloud computer 12 initially does not display any slider bar until after the user clicks on a specific part of the line that represents the location of the target (e.g. entrepreneur being measured) on the line (step 191). Only after the user clicks on the line does a slider-bar appear wherein a numerical feedback display appears on said slider-bar (step 192). This accomplishes: a) avoid central tendancy bias with visual cues; and b) give another point of feedback to the rater about the level of their rating with efficient use of screen real-estate. Cloud computer 12 allows the administrator to choose to store the dynamic movements of the slider bar of the rater, including the entire session of the length of time pondering the item, and the specific locations of the slider bar throughout the session including but not limited to the final location (step 193). This enables subsequent analyses about rater behaviors while contemplating a rating that is not possible with prior art inventions (step 194).

The aforementioned invention is preferred to promote deeper thinking and avoiding response sets in raters, while collecting a larger array of data about their behavior as elicited during the rating process than is possible with prior art inventions.

Dynamic Rater Bias Remediation.

The current invention further maximizes the possibility for rater data to be useful. When the administrator is able to include prior known calibrated item location parameters, they can set the system to automatically estimate the individual rater difficulty and adjust estimates to be fair given whatever bias may be present for a given rater.

After each rater response, if the system detects misfit that do not meet the admin's quality control standards (e.g. infit and outfit not between 0.7-1.2), then the administrator can have the system terminate early, or move on to another scale. Before administering another scale, the preferred embodiment estimates the likely time required to complete, and optimize total number of items, based on the largest acceptable standard error and minimum number of items required to calculate quality control standards).

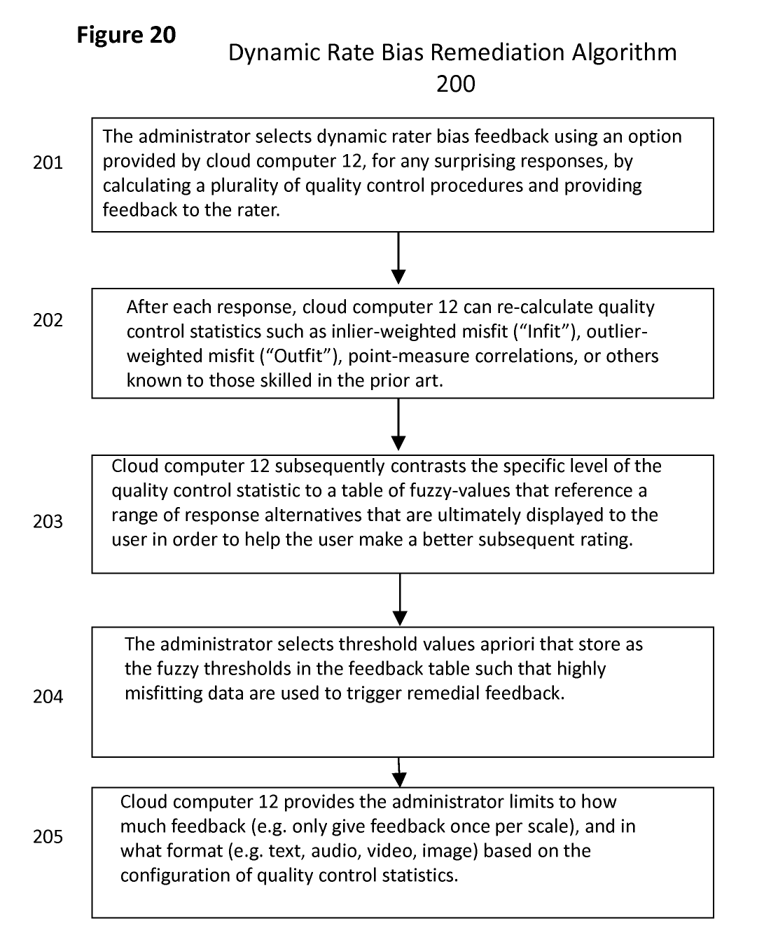

FIG. 20 depicts a dynamic rate bias remediation algorithm 200. In this embodiment, the administrator selects dynamic rater bias feedback using an option provided by cloud computer 12, for any surprising responses, by calculating a plurality of quality control procedures and providing feedback to the rater (step 201). After each response, cloud computer 12 can re-calculate quality control statistics such as inlier-weighted misfit (“Infit”), outlier-weighted misfit (“Outfit”), point-measure correlations, or others known to those skilled in the prior art (step 202). Cloud computer 12 subsequently contrasts the specific level of the quality control statistic to a table of fuzzy-values that reference a range of response alternatives that are ultimately displayed to the user in order to help the user make a better subsequent rating (step 203). The administrator selects threshold values apriori that store as the fuzzy thresholds in the feedback table such that highly misfitting data are used to trigger remedial feedback (step 204). Cloud computer 12 provides the administrator limits to how much feedback (e.g. only give feedback once per scale), and in what format (e.g. text, audio, video, image) based on the configuration of quality control statistics (step 205).

Social Media Item Generation & Calibration.

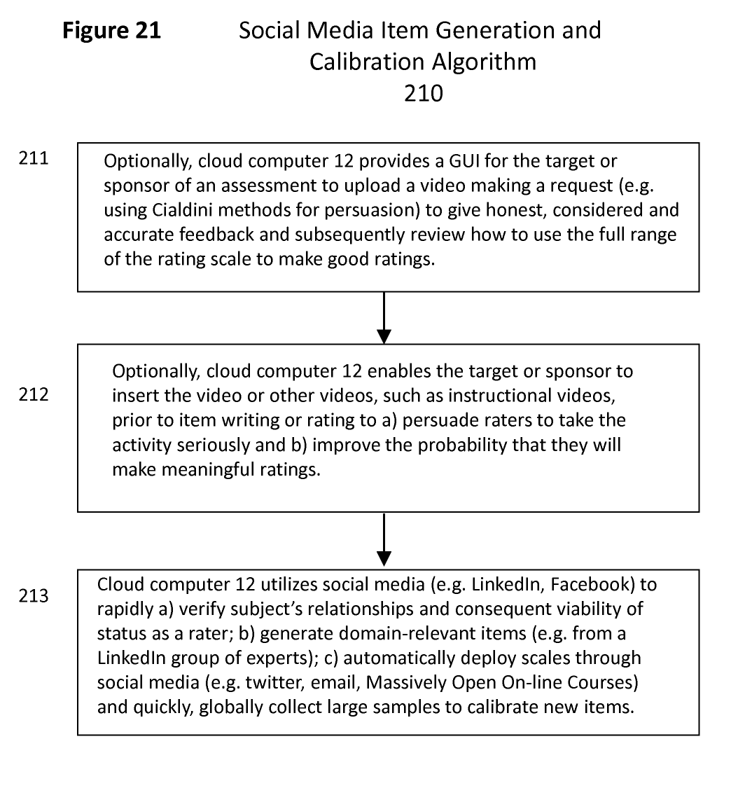

FIG. 21 depicts a social media item generation and calibration algorithm 210. Optionally, cloud computer 12 provides a GUI for the target or sponsor of an assessment to upload a video making a request (e.g. using Cialdini methods for persuasion) to give honest, considered and accurate feedback and subsequently review how to use the full range of the rating scale to make good ratings (step 211). Optionally, cloud computer 12 enables the target or sponsor to insert the video or other videos, such as instructional videos, prior to item writing or rating to a) persuade raters to take the activity seriously and b) improve the probability that they will make meaningful ratings (step 212). Cloud computer 12 utilizes social media (e.g. LinkedIn, Facebook) to rapidly a) verify subject's relationships and consequent viability of status as a rater; b) generate domain-relevant items (e.g. from a LinkedIn group of experts); c) automatically deploy scales through social media (e.g. twitter, email, Massively Open On-line Courses) and quickly, globally collect large samples to calibrate new items (step 213).

Rater Remediation.

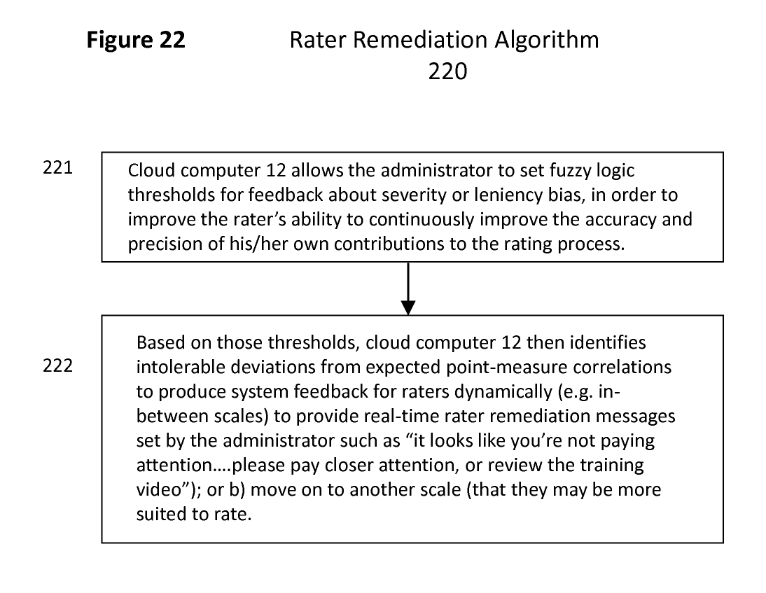

The preferred embodiment of the invention includes real-time calculation of rater severity/leniency, misfit and negative-point measure ratings. FIG. 22 depicts a rater remediation algorithm 220. Cloud computer 12 allows the administrator to set fuzzy logic thresholds for feedback about severity or leniency bias, in order to improve the rater's ability to continuously improve the accuracy and precision of his/her own contributions to the rating process (step 221). Based on those thresholds, cloud computer 12 then identifies intolerable deviations from expected point-measure correlations to produce system feedback for raters dynamically (e.g. in-between scales) to provide real-time rater remediation messages set by the administrator such as “it looks like you're not paying attention . . . please pay closer attention, or review the training video”); or b) move on to another scale (that they may be more suited to rate) (step 222.

Video & Text Feedback for Targets.

One embodiment of the invention further allows raters to give text, web-cam or mobile-cam based open-ended video feedback by dimension, if the rater gives permission. The preferred embodiment reminds raters that the video will be viewable (and identifiable) by the target; that that the best feedback is specific and behavioral. This feature is especially preferred when the assessment's purpose is at least in part for developmental feedback.

Rater Quality Improvement.

In one embodiment, the system generates a report for raters to better understand their rater bias (if any) following a session, to help them continuously improve. The preferred embodiment further includes a plurality of videos and job-aides that it emails, makes available via a mobile application or web application such that the resultant output is matched to the level of bias the rater exhibited (e.g. large misfit through zero misfit) and suggests specific remediation, so that the raters can continuously improve their ability to rate in a mass-customized way. Further, the preferred embodiment includes evidence-based instructions on making ratings.

Verification of Rater Sample.

The preferred embodiment has several novel solutions to reduce the probability of misrepresentation and outright fraud in both raters and actual rating. First, the invention allows a target to propose a set of stakeholders for review by another person (e.g. Venture Capitalist, Hiring manager). Cloud computer 12 provides a separate password-protected region for a customer (e.g. Venture Capitalist, hiring manager) to review a given proposed set of stakeholders (e.g. subordinates, peers, clients) provided by a target (e.g. CEO wanting funding) and compare with other data about known colleagues (e.g. whether they are present on the person's LinkedIn profile) prior to finalizing the selection of raters to include email addresses of other stakeholders that may not have been in the social media sources.

Second, cloud computer 12 provides a separate interface for experts in the domain (e.g. Psychologists, Engineers) to rate social media, publications or other domain-relevant artifacts uploaded into the system for the purpose of evaluating various dimensions for assessment (e.g. personality, domain expertise).

Third, those skilled in the prior art will recognize that there are other mechanisms that allow a system to verify the identity of a target for assessment who has previously taken an unproctored assessment (e.g. web/cloud/wireless). Prior art systems use the prior unproctored score: consider the standard error as a given, and re-test the same person, to reject the hypothesis that they are not significantly below that same level, thereby confirming that they did not have another person complete the unproctored assessment. Prior art systems do this with one dimension and only with confidence intervals.

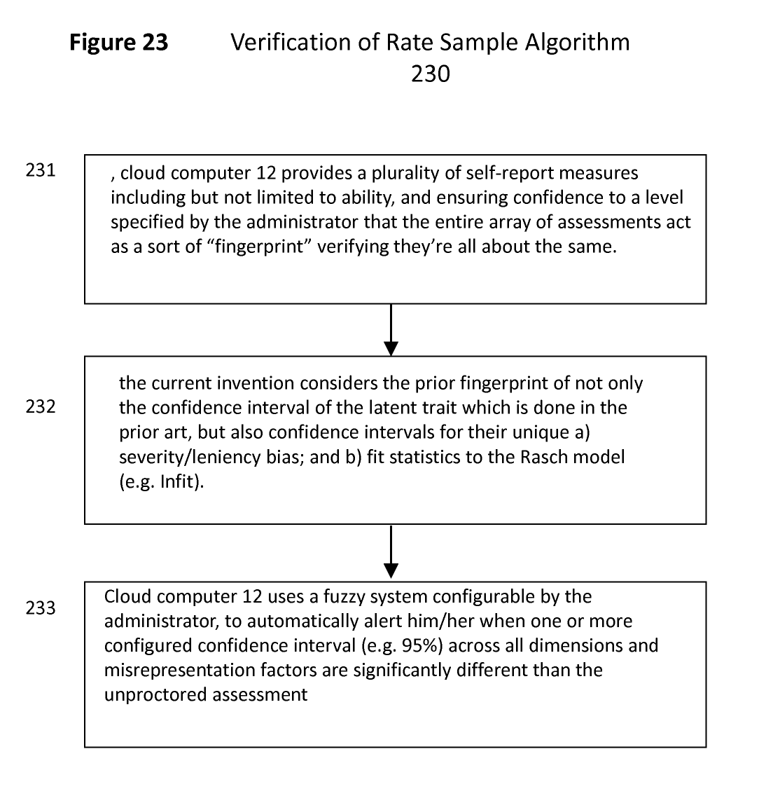

FIG. 23 depicts a verification of rate sample algorithm 230. In the preferred embodiment, cloud computer 12 provides a plurality of self-report measures ensuring confidence to a level specified by the administrator that the entire array of assessments act as a sort of “fingerprint” verifying they're all approximately the same (step 231). Further, even in a single dimension embodiment, the current invention considers the prior fingerprint of not only the confidence interval of the latent trait which is done in the prior art, but also confidence intervals for their unique a) severity/leniency bias; and b) fit statistics to the Rasch model (e.g. Infit) (step 232). Cloud computer 12 uses a fuzzy system configurable by the administrator, to automatically alert him/her when one or more configured confidence interval (e.g. 95%) across all dimensions and misrepresentation factors are significantly different than the unproctored assessment (step 233).

Rater Enthusiasm Improvements.

The preferred embodiment of the invention improves the probability that the requested raters complete the assessment by using Cialdini's Principle of Reciprocity (2001) known in the prior art embedded into the technology. It encourages the targets (beneficiaries of the measurement) to provide an opportunity to give an intangible or tangible gift to other stakeholders.

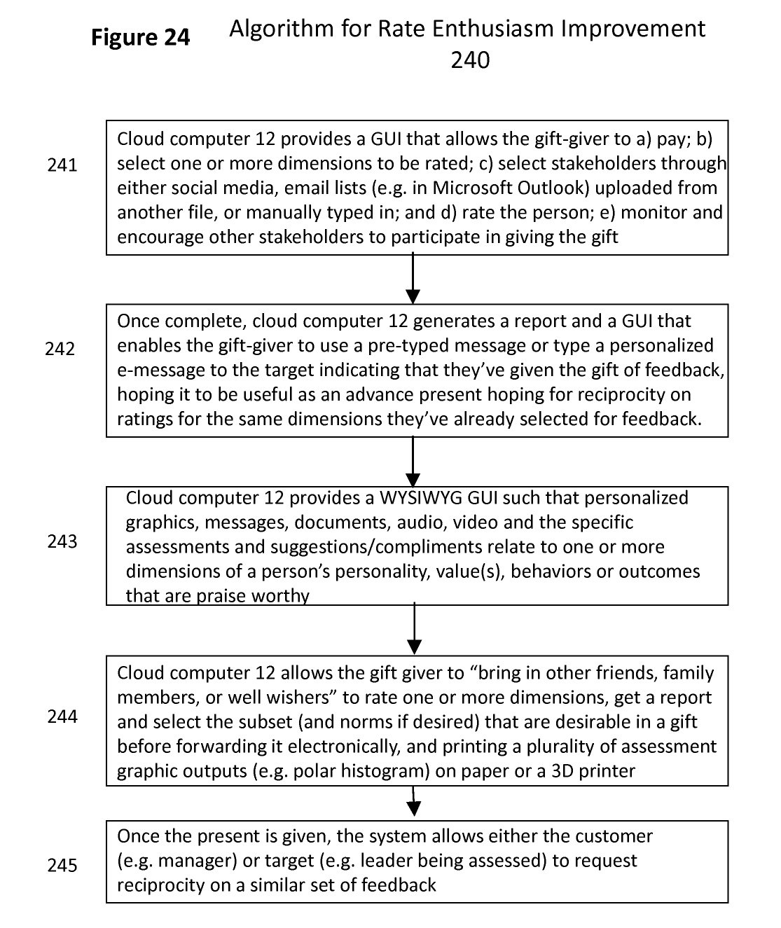

FIG. 24 depicts an algorithm for rate enthusiasm improvement 240. In the preferred embodiment, cloud computer 12 provides a GUI that allows the gift-giver to a) pay; b) select one or more dimensions to be rated; c) select stakeholders through either social media, email lists (e.g. in Microsoft Outlook) uploaded from another file, or manually typed in; and d) rate the person; e) monitor and encourage other stakeholders to participate in giving the gift (step 241). Once complete, cloud computer 12 generates a report and a GUI that enables the gift-giver to use a pre-typed message or type a personalized e-message to the target indicating that they've given the gift of feedback, hoping it to be useful as an advance present hoping for reciprocity on ratings for the same dimensions they've already selected for feedback (e.g. leadership) (step 242). Further, cloud computer 12 provides a WYSIWYG GUI such that personalized graphics, messages, documents, audio, video and the specific assessments and suggestions/compliments relate to one or more dimensions of a person's personality, value(s), behaviors or outcomes that are praise worthy (step 243). Cloud computer 12 allows the gift giver to “bring in other friends, family members, or well wishers” to rate one or more dimensions, get a report and select the subset (and norms if desired) that are desirable in a gift before forwarding it electronically, and printing a plurality of assessment graphic outputs (e.g. polar histogram) on paper or a 3D printer (step 244). Once the present is given, the system allows either the customer (e.g. manager) or target (e.g. leader being assessed) to request reciprocity on a similar set of feedback (step 245).

Meaningful Contrasts.

In the prior art, it is common for multiple stakeholder ratings to be estimated separately, but with classical test theory-based true score estimates. A serious limitation to prior art 360s is they lack the ability to control for rater bias (e.g. severity/leniency). Unfortunately, this is a fatal flaw because psychometricians skilled in the prior art will recognize that rater variation often outstrips target (e.g. leader) variation, thereby making CTT-based multisource assessments useless. Further, because the prior art uses the deficient classical test theory, it has large standard errors in the tails of the distribution where the measures are most important (very high and very low).

In contrast, the current invention's preferred embodiment is Rasch Measurement based, that ensures linear measures with consistently small standard errors across the full range of interest. In addition to one measure for the leader—the single best estimate of their location—it is within the spirit and scope of the current invention that multiple contrasts of confidence intervals or other statistical tests may be deployed by an analyst in order to compare between raters, between raters and the leader's location, and across time when considered across multiple periods.

Fatigue Prevention & Optimization.

Multisource assessments, such as are required to evaluate constructs like leadership are by definition those that survey multiple stakeholders. This exacerbates the sheer length of time and fatigue that stakeholders have in providing feedback. On the other hand, more data are more useful because they're more precise.

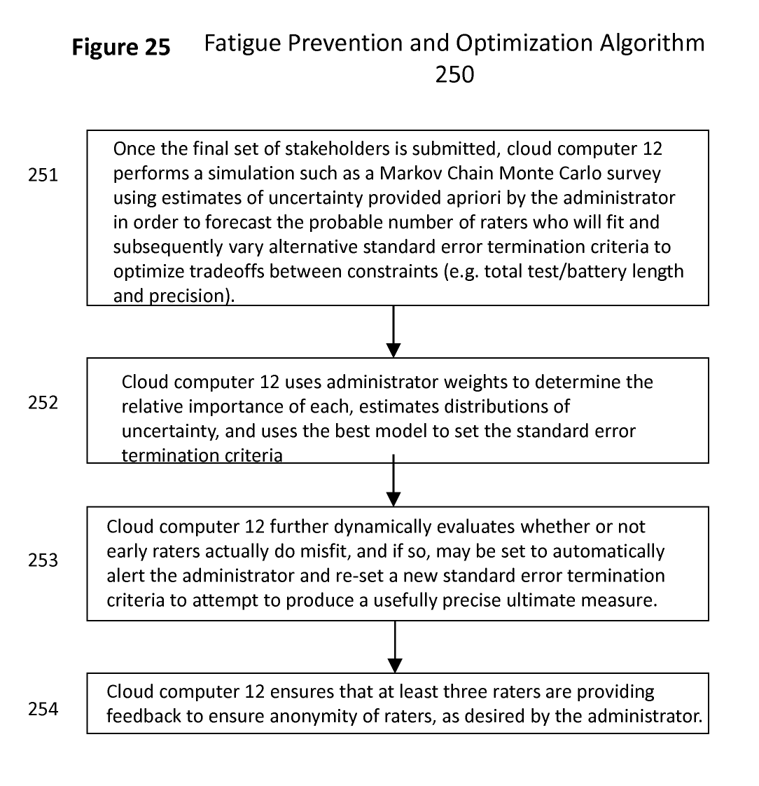

A fatigue prevention and optimization algorithm is depicted in FIG. 25. The preferred embodiment of the solution includes an expert system to automatically setting up a new multisource assessment to adjust complex tradeoffs between the total number of raters selected for inclusion in a study and the termination criterion required to stop a computer-adaptive measure. Once the final set of stakeholders is submitted, cloud computer 12 performs a simulation such as a Markov Chain Monte Carlo analysis using estimates of uncertainty provided apriori by the administrator in order to forecast the probable number of raters who will fit and subsequently vary alternative standard error termination criteria to optimize tradeoffs between constraints (e.g. total test/battery length and precision) (step 251). Cloud computer 12 uses administrator weights to determine the relative importance of each, estimates distributions of uncertainty, and uses the best model to set the standard error termination criteria (step 252). Cloud computer 12 further dynamically evaluates whether or not early raters actually do misfit, and if so, may be set to automatically alert the administrator and re-set a new standard error termination criteria to attempt to produce a usefully precise ultimate measure (step 253). Cloud computer 12 ensures that at least three raters are providing feedback to ensure anonymity of raters, as desired by the administrator (step 254).

Feedback Improvement.

It is known to experts in the prior art that there is relatively little benefit for raters to provide feedback to another person in a multisource survey. This invention provides feedback that the rater may find useful as a reward for participation.

The preferred embodiment uses Rasch measurement, but other paradigms can be substituted (e.g. Item Response Theory) known to those skilled in the prior art. The unique benefit of the Rasch approach in the preferred embodiment is the ability to generate thermometer-like reports where the facet element locations are on the same line (e.g. person and item locations). The preferred embodiment provides a report in an electronic or printable form (e.g. 3D Printer) depicting the item-specific content (e.g. behaviors) matched to the level of the person, such that the recommended actions are neither too easy nor too hard for the target to work on for development.

Further, the preferred embodiment automates feedback based on apriori thresholds set by an administrator. The administrator uses a GUI to establish the ranges for pre-authored feedback to be given to targets (e.g. leaders) whose confidence interval overlaps with the region. The preferred embodiment deploys both dynamically-authored text and expert video based feedback along with option for the end-user to receive dynamic virtual coaching.

In this way, there is an extra incentive that can be made known to raters apriori that they will get valuable feedback about how accurate and precise their own feedback was, so that they can improve their own self-insight into their processes of evaluating behavior of others or themselves. For some raters, this reward for good, accurate feedback may improve their probability of participating fully, unlike inventions in the prior art with no such reward.

Bootstrapped Rating Quality Improvement.

The preferred embodiment further improves rating quality by examining the misfit and person location estimates when resampling both individual raters, and also entire sets of data from specific raters in order to better estimate a confidence interval for each; and consequently remove raters that are misfitting.

An alternative embodiment is able to examine hypothetical bootstrapped results as if the same person's exact ratings were used multiple times in order to examine whether or not that would reduce misfitting. If it would, it suggests the misfitting is an artifact of the CAT having very few responses that are especially sensitive to specific responses—more so than non-CAT misfit.

Development Intervention Experimental Engine.

The preferred embodiment focuses a given participant (e.g. leader) on one or more developmental solutions that are aligned with his/her personal development plan, providing a diverse plurality of evidence-based interventions that administrators have included from prior research showing the appropriate combination of formal (e.g. books, simulations, Massively Online Open Courses, job aides, mentoring) and informal solutions (e.g. bulletin boards, coaching, experiential projects, job shadowing) that will increase his/her probability of realizing his/her goals. The current invention massively scales evidence-based leader development in several ways.

First, utilizing the data established previously about what specific dimension(s) and levels the participant has committed to improve, the system uses fuzzy logic to invite him/her to join a cohort group with one or more similar developmental needs. It is within the spirit and scope of the invention to make a cohort group one defined by the administrator, target, or investor (e.g. Startup Accelerator). In the event that no cohort group can be found that matches the confidence interval of the participant, the system broadens the search for a cohort accepting open invitations to those working on the same dimension.

Second, participants are assigned randomly to different groups automatically by the system in order to ensure that subsequent changes are done with experimental controls. Those skilled in prior art statistics will recognize this component of the invention as invaluable for making causal inferences in one or more alternatives, sometimes called “A/B” testing by those in the startup and marketing industries.

The system allocates entrepreneurs entirely randomly or in such a way as to stratify by proximity to others, or by timezone when the administrator desires more synchronous solutions that can be done “in person” (e.g. meetup group). A minimum of two groups per domain is required, and the preferred embodiment encourages the participant to invite others in this effort (e.g. MOOC), using social media outlets (e.g. Facebook, LinkedIn, email) such that a sufficiently large sample is selected into the experimental conditions.

The preferred embodiment allows the administrator to specify apriori required levels of minimum statistical power required, and expected effect sizes of experimental procedures that, when realized, will trigger the system to closing off a given experimental developmental opportunity for a specific set of cohorts. The administrator further is able to input text, video and other informational materials required for the pedagogical experiment. The preferred embodiment allows the administrator to set up a competition; or allows to cohorts to upload specific challenges related to the domain they had previously committed to developing. The system explains that the cohort is all similar in that they're working on a given dimension previously measured, and that their job is to help each other all grow, and that they're competing against the other cohort group, and that the only way to win is to help everyone win. The preferred embodiment uses videos and texts to persuade cohort groups to participate in self-paced, or social-media enabled learning experiences such that they provide online mentoring, support, and resources. The preferred embodiment allows cohort participants to securely (private within a cohort) upload videos or work samples that other users within the cohort can rate using the computer-adaptive measurement system previously described. The preferred embodiment further encourages the administrator to upload one substantive developmental intervention difference (e.g. different class) between cohorts, to evaluate whether or not it seems to improve development. The preferred embodiment uses an administrator-specified time limit to motivate cohort groups to complete their development in a timely fashion, and then calculate the winning cohort group automatically using the system-generated measures for all participants within a cohort and a plurality of prior-art statistical methods (e.g. ANOVA) and announces a winner in one or more modalities (e.g. text, video, twitter, LinkedIn, Facebook), the preferred embodiment is simultaneously on bulletin boards, blogs, social media (e.g. twitter, Linkedin) and press releases further enhancing the probability of virality of future users of both the measurement and development inventions.

Within Cohort Developmental Catalyst.

The preferred embodiment uses quality improvements for both stakeholder motivation, and rating accuracy/precision. The system updates cohorts with aggregate statistics on cohorts improvements, comparing them with competing ‘teams” in improving their development (e.g. confidence intervals, t-tests), providing additional motivational elements to complete learning objects greater than innovations available in the prior art. Further, rater severity/leniency and misfit biases are stored by the system in order to give feedback to raters on their accuracy and precision, and once rater standard errors are sufficiently small, to store these and use as a constant in future measurement iterations.

Cryptocurrency Game Incentives and Payoff.

One embodiment includes either programmable cryptographically encrypted currency (e.g. Bitcoin), or application protocol interfaces with other forms of fiat currency (e.g. PayPal, Mastercard) to automatically provide a mechanism for one or more administrators, or a separate manager GUI, to provide incentives for the person, team, or division that grows the most. This can provide a systematic extra monetary incentive for individuals, teams, or groups to take their development seriously. The system allows for a plurality of prizes to be defined by the admin or manager, including highest overall performance, biggest improvement, or any other combination that is programmable within the interface, through either drag-and-drop object-oriented controls, or a command line interface. The preferred embodiment triggers a quantitative analysis of the participants, and scores them. Next, it compares confidence intervals, and does not payoff unless at least one person/team/group is significantly better than the prior measurement. The preferred embodiment triggers an automatic payoff, or partial payoff to the winner(s) in cryptocurrency, thereby enabling cross-border competitions to seamlessly provide financial incentives without worrying about currency conversion, or fiat currency devaluation.

eCoaching/Simulation Real-Time Development.

The preferred embodiment includes permission-based features for participants in a given cohort to have access to periodic feedback and suggestions in web, email, and mobile application formats. In order to support the transfer of new skills onto the job, improve performance (e.g. conceptualize better Minimum Viable Product) or enhance self-regulatory mechanisms (e.g. identity, learning goal orientation), the system enables the developer of a given instructional or developmental solution for a given cohort to give out additional assignments that are devised specifically for the specific confidence interval of the person attempting to develop. This may include recurring meeting requests integrated into a calendar (e.g. Microsoft Outlook) already available in the prior art; or Short Message Service (SMS) reminders; emailed hyperlinks; web/mobile application based serious games or simulations or a combination thereof. The preferred embodiment further enables synchronous methods for periodic real-time updates with either social media or instructors providing video and/or telephony-based feedback, recommendations and answers to complex questions.

Evidence-Based Solution Aggregation.

As each experiment completes, the system aggregates the most winning solutions that appear to be most effective at growing the given dimension or level of dimension, if there are any statistical differences between groups found. The system allows for the provision of purchasing data about the portfolio of solutions most likely to be successful in development; as well as selling access to the specific winning solutions. The preferred embodiment provides future competitions for new experimental samples only based on competing with the previous winner, ensuring continuous quality improvement of a given type of solution.

Cross-Level Developmental Evaluations.

It is known to those in the prior art that no one single intervention is likely sufficient to develop people, especially at the highest levels. And even when this is possible, the probability of development is superior when there are multiple points of developmental support including new opportunities to practice, experience support, and exercising skill against new challenges across the full continuum of interest. The preferred embodiment automatically calculates the forecast effect of a combination of winning experimental interventions examined previously, to recommend, a portfolio of developmental solutions for a given target that will dramatically achieve their objectives. The preferred embodiment further forecasts the likely future skill level, upon re-measurement, if the target chooses to invest fully in the entire array of evidence-based solutions. This can include many cross-level statistical methods known to those in the prior art (e.g. Instrumental Regression). Such models are valuable for career planning, helping targets to focus development on areas with the biggest opportunity and not to develop areas that are unlikely to get much better to advance their career. Forecast outcomes include promotion level, job type, value to the company, and performance in a given job.

Video Persuasion.

The preferred embodiment uses a system that allows the target (beneficiary) of the assessment to provide an audio/videorecording (e.g. using their webcam and microphone) explaining how important the feedback is to him/her, what he will lose if they don't care to participate, or take it seriously and other principles known to those skilled in the scientific principles of persuasion (Cialdini, 2011). This improves the probability that targeted raters take the situation seriously, complete all the questions to the best of their ability and therefore will not misfit the quality control statistics in later stages of the automated Rasch Measurement process. The invention allows the target to make a video that all stakeholders may see, a subset (e.g. by stakeholder type) or individual for each unique rater (preferred embodiment) to improve the rating quality.

Portfolio Monitoring, Evaluation and Remediation.

The preferred embodiment further provides a meta-overview of the entire value chain of a given leader's domain (e.g. pre-launch entrepreneur through IPO or buyout) that reports on the stochastic progress a plurality of leaders are making through a process. For example, it could be a high-potential leader in a succession development process; or an entrepreneurial leader seeking funding at various stages, such as seed, A, B, C or D-series. It includes methods for the administrator to establish warnings based on apriori thresholds known to those in the prior art (e.g. Quality, Cost, Quantity and/or Cycle Time), and color coding a dashboard of the flow of both value and of the change of the leader attributes and behavior over time. The administrator uses a GUI to select times for re-assessment, and details on personal development progress required to de-risk goal attainment, and the system reports a plurality of ways for the administrator to view said progress. The preferred embodiment calculates confidence intervals and reports whether or not a given leader, team or organization had significantly improved since the prior measurement period.

Further, persons knowledgeable about prior art research will know that existing inventions are unable to satisfactorily handle the “filedrawer” problem, such that persons exit samples and bias resultant statistical analyses. Consequently, what is needed is a tracking functionality to identify not only the relationship between predictors and criteria, but also looking at how the criteria evolve over time including survival rates (e.g. leader attrition, firm bankruptcies).

“Big Data” Longitudinal Modeling & Evaluation.

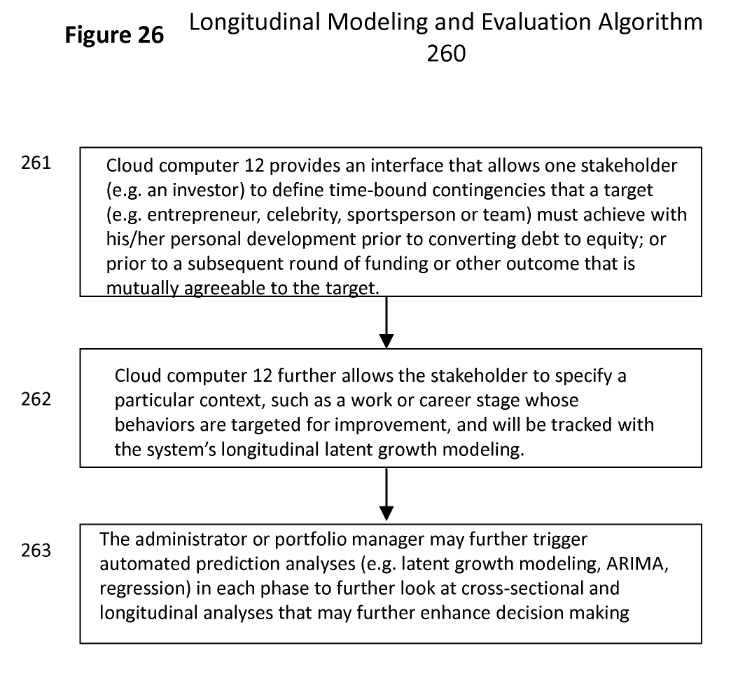

One embodiment of the current invention further provides an interface for talent managers to track a portfolio of individuals (e.g. high potential leaders), and the ongoing financial, client, and other performance consequences of targeted persons and teams' measures in the prior feature sets. FIG. 26 depicts a longitudinal modeling and evaluation algorithm. Cloud computer 12 provides an interface that allows one stakeholder (e.g. an investor) to define time-bound contingencies that a target (e.g. entrepreneur, celebrity, sportsperson or team) must achieve with his/her personal development (e.g., prior to promotion; prior to converting debt to equity; or prior to a subsequent round of funding or other outcome that is mutually agreeable to the target) (step 261). This featureset allows the stakeholder to define the frequency and dimensions for periodic re-assessments (e.g. monthly, quarterly) that would be required to improve to a particular standard prior to a consequence triggering (e.g. funding). Cloud computer 12 further allows the stakeholder to specify a particular context, such as a work or career stage whose behaviors are targeted for improvement, and will be tracked with the system's longitudinal latent growth modeling (step 262). For example, when used by a Venture Capitalist, the system tracks predictors and criteria for pre-launch and pre-funded firms separately from those that are funded but searching for a business model; and finally separately from those firms that are scaling. The administrator or portfolio manager may further trigger automated prediction analyses (e.g. latent growth modeling, ARIMA, regression) in each phase to further look at cross-sectional and longitudinal analyses that may further enhance decision making (step 263).

The system allows for software-based integration with other systems (e.g. APIs), or manual entry by an end user through a graphical user interface. Further, when the system is used for manual entry, it provides reminders to the data entry specialist about the timing of the required updates (e.g. quarterly) to mitigate the risk of missing data.

It is further known to experts in the prior art that in high-stakes testing situations, faking “good” responses, or actively undermining the examination process to favor the target is common. It is similarly known to those in the prior art that honest, well meaning subjects may unintentionally misrepresent themselves because of a wide variety of cognitive biases known to those in the prior art. While the multisource, Rasch-based nature of the current invention mitigates both types by having other people rate, and adjusting for rater biases, there is still the possibility of systematic undermining of the assessment process. One more novel feature of the current invention is the introduction of Global Positioning System (GPS)-based fraud detection:

Multifaceted Fraud Detection.

The current invention's preferred embodiment is to verify the location-based identity of the person who is claiming to provide the ratings.

At the discretion of the administrator, or other non-target stakeholder (e.g. investor), cloud computer 12 can verify the location of the person by identifying the internet address's GPS location and asking the user to send his or her country code and cellphone ID via SMS to verify his or her identity. Cloud computer 12 comprises or has access to a database of known internet addresses matched to internet service providers, and cellphone providers (with tunneled permission) to confirm identity. If a discrepancy arises between the data provided by the person and the GPS or database information, the ratings from that person can be discarded and/or that person can be denied access to the services of cloud computer 12.

What is claimed is:

1. A method of automating measurements of survey data, comprising:
establishing, using a cloud computer, a survey;
administering a survey to a plurality of users using a plurality of computing devices;
gathering, by the cloud computer, data from the plurality of computing devices;
performing, by the cloud computer, scale disorder correction;
performing, by the cloud computer, facet distortion correction; and
generating a report of results of the survey.

2. The method of claim 1, wherein the step of performing scale disorder correction comprises using the Many Facet Rasch Model.

3. The method of claim 1, wherein the step of performing facet distortion correction comprises using the Many Facet Rasch Model.

4. The method of claim 1, wherein the step of performing scale disordering correction comprises concatenating two scale categories if the cloud computer detects misfit or disordering in a single category within the survey.

5. The method of claim 1, wherein the step of performing facet distortion correction comprises removing elements from all low priority facets with poor point-measure correlation.

6. A cloud computer configures to automate measurements of survey data, comprising:
a cloud computer configured to establish a survey, administer the survey to a plurality of computing devices, gather data from the plurality of computing devices, to perform scale disorder correction on the data, to perform facet distortion correction on the data, and to generate a report on the survey.

7. The cloud computer of claim 6, wherein the scale disorder correction comprises using the Many Facet Rasch Model.

8. The cloud computer of claim 6, wherein the facet distortion correction comprises using the Many Facet Rasch Model.

9. The cloud computer of claim 6, wherein the scale disordering correction comprises concatenating two scale categories if the cloud computer detects misfit or disordering in a single category within the survey.

10. The cloud computer of claim 6, wherein the performing facet distortion correction comprises removing elements from all low priority facets with poor point-measure correlation.

11. A method of performing dynamic rate bias remediation, comprising:
receiving, by a cloud computer, a response to a survey question;
calculating, by the cloud computer, a quality control statistic;
comparing the results of the calculating step to stored threshold values; and
providing feedback if one or more of the results exceed one or more stored threshold values.

12. The method of claim 11, wherein the quality control statistic comprises one or more of inlier-weighted misfit, outlier-weighted misfit, or point-measure correlations.

13. The method of claim 11, wherein the feedback comprises one of text, audio, video, and images.

14. The method of claim 11, wherein the feedback is provided at a predetermined frequency.

15. The method of claim 14, wherein the frequency is once per scale.

16. A cloud computer configured to perform dynamic rate bias remediation, comprising:
a cloud computer configured to receive a response to a survey question, to calculate a quality control statistic, to compare the result of the calculating step to stored threshold values, and to provide feedback if one or more of the results exceed one or more stored threshold values.

17. The cloud computer of claim 15, wherein the quality control statistic comprises one or more of inlier-weighted misfit, outlier-weighted misfit, or point-measure correlations.

18. The cloud computer of claim 15, wherein the feedback comprises one of text, audio, video, and images.

19. The cloud computer of claim 15, wherein the feedback is provided at a predetermined frequency.

20. The cloud computer of claim 19, wherein the frequency is once per scale.
